(19) United States
(12) Patent Application Publication
(10) Pub. No.: US 2018/0305474 A1
(43) Pub. Date: Oct. 25, 2018

(54) COMPLEXES AND THEIR USE FOR OLEFIN POLYMERIZATION

(71) Applicant: SCG CHEMICALS CO., LTD., Bangsue Bangkok (TH)

(72) Inventors: Dermot O'HARE, Oxford (GB); Jean-Charles BUFFET, Oxford (GB); Zoe TURNER, Oxford (GB); Duncan FRASER, Oxford (GB)

(21) Appl. No.: 15/766,155

(22) PCT Filed: Oct. 4, 2016
(86) PCT No.: PCT/GB2016/053086

§ 371 Date: Apr. 5, 2018

(30) Foreign Application Priority Data
Oct. 6, 2015 (GB) 1517650.6

(51) Int. Cl. C08F 10/02; C07F 17/00

(52) U.S. Cl. CPC C08F 10/02; C07F 17/00

(57) ABSTRACT

Permethylpentalene based metallocene complexes are disclosed. The complexes are effective catalysts/initiators in the polymerisation of olefins. Also disclosed are compositions comprising the metallocene complexes, as well as uses of the complexes and compositions in olefin polymerisation.

### INTRODUCTION

The present invention relates to catalysts. More specifically, the present invention relates to particular metallocene catalysts, and the use of such catalysts in olefin polymerization reactions. Even more specifically, the present invention relates to metallocene catalysts containing permethyl pentalene ligands, and the use of such catalysts in ethylene polymerization reactions.

### BACKGROUND OF THE INVENTION

It is well known that ethylene (and α-olefins in general) can be readily polymerized at low or medium pressures in the presence of certain transition metal catalysts. These catalysts are generally known as Zeigler-Natta type catalysts.

A particular group of these Ziegler-Natta type catalysts, which catalyse the polymerization of ethylene (and α-olefins in general), comprise an aluminoxane activator and a metallocene transition metal catalyst. Metallocenes comprise a metal bound between two η⁵-cyclopentadienyl type ligands.

Numerous metallocenes catalysts are known in the art. However, there remains a need for improved metallocene catalysts for use in olefin polymerization reactions. In particular, there remains a need for new metallocene catalysts with high polymerization activities/efficiencies.

The present invention was devised with the foregoing in mind.

### SUMMARY OF THE INVENTION

According to a first aspect of the present invention, there is provided a compound of formula I defined herein.

According to another aspect of the present invention, there is provided a composition comprising a compound of formula I defined herein and at least one suitable activator.

According to another aspect of the present invention, there is provided a use of a compound of formula I defined herein, or a composition defined herein, in the polymerisation of olefins.

According to another aspect of the present invention, there is provided a process for polymerising one or more olefins, said process comprising the step of polymerising the one or more olefins in the presence of
(i) a compound of formula I defined herein, or a composition defined herein; and
(ii) a suitable activator.

According to another aspect of the present invention, there is provided a polymer obtainable, obtained or directly obtained by a process defined herein.

### DETAILED DESCRIPTION OF THE INVENTION

### Definitions

The term “alkyl” as used herein includes reference to a straight or branched chain alkyl moieties, typically having 1, 2, 3, 4, 5 or 6 carbon atoms. This term includes reference to groups such as methyl, ethyl, propyl (n-propyl or isopropyl), butyl (n-butyl, sec-butyl or tert-butyl), pentyl (including neopentyl), hexyl and the like. In particular, an alkyl may have 1, 2, 3 or 4 carbon atoms.

The term “alkenyl” as used herein include reference to straight or branched chain alkenyl moieties, typically having 2, 3, 4, 5 or 6 carbon atoms. The term includes reference to alkenyl moieties containing 1, 2 or 3 carbon-carbon double bonds (C═C). This term includes reference to groups such as ethenyl (vinyl), propenyl (allyl), butenyl, pentenyl and hexenyl, as well as both the cis and trans isomers thereof.

The term “alkynyl” as used herein include reference to straight or branched chain alkynyl moieties, typically having 2, 3, 4, 5 or 6 carbon atoms. The term includes reference to alkynyl moieties containing 1, 2 or 3 carbon-carbon triple bonds (CEC). This term includes reference to groups such as ethynyl, propynyl, butynyl, pentynyl and hexynyl.

The term “alkoxy” as used herein include reference to —O-alkyl, wherein alkyl is straight or branched chain and comprises 1, 2, 3, 4, 5 or 6 carbon atoms. In one class of embodiments, alkoxy has 1, 2, 3 or 4 carbon atoms. This term includes reference to groups such as methoxy, ethoxy, propoxy, isopropoxy, butoxy, tert-butoxy, pentoxy, hexoxy and the like.

The term “aryl” as used herein includes reference to an aromatic ring system comprising 6, 7, 8, 9 or 10 ring carbon atoms. Aryl is often phenyl but may be a polycyclic ring system, having two or more rings, at least one of which is aromatic. This term includes reference to groups such as phenyl, naphthyl and the like.

The term “carbocyclyl” as used herein includes reference to an alicyclic moiety having 3, 4, 5, 6, 7 or 8 carbon atoms. The group may be a bridged or polycyclic ring system. More often cycloalkyl groups are monocyclic. This term includes reference to groups such as cyclopropyl, cyclobutyl, cyclopentyl, cyclohexyl, norbornyl, bicyclo[2.2.2]octyl and the like.

The term “heterocyclyl” as used herein includes reference to a saturated (e.g. heterocycloalkyl) or unsaturated (e.g. heteroaryl) heterocyclic ring moiety having from 3, 4, 5, 6, 7, 8, 9 or 10 ring atoms, at least one of which is selected from nitrogen, oxygen, phosphorus, silicon and sulphur. In particular, heterocyclyl includes a 3- to 10-membered ring or ring system and more particularly a 5- or 6-membered ring, which may be saturated or unsaturated.

A heterocyclic moiety is, for example, selected from oxiranyl, azirinyl, 1,2-oxathiolanyl, imidazolyl, thienyl, furyl, tetrahydrofuryl, pyranyl, thiopyranyl, thianthrenyl, isobenzofuranyl, benzofuranyl, chromenyl, 2H-pyrrolyl, pyrrolyl, pyrrolinyl, pyrrolidinyl, imidazolyl, imidazolidinyl, benzimidazolyl, pyrazolyl, pyrazinyl, pyrazolidinyl, thiazolyl, isothiazolyl, dithiazolyl, oxazolyl, isoxazolyl, pyridyl, pyrazinyl, pyrimidinyl, piperidyl, piperazinyl, pyridazinyl, morpholinyl, thiomorpholinyl, especially thiomorpholino, indolizinyl, isoindolyl, 3H-indolyl, indolyl, benzimidazolyl, cumaryl, indazolyl, triazolyl, tetrazolyl, purinyl, 4H-quinolizinyl, isoquinolyl, quinolyl, tetrahydroquinolyl, tetrahydroisoquinolyl, decahydroquinolyl, octahydroisoquinolyl, benzofuranyl, dibenzofuranyl, benzothiophenyl, dibenzothiophenyl, phthalazinyl, naphthyridinyl, quinoxalyl, quinazolinyl, quinazolinyl, cinnolinyl, pteridinyl, carbazolyl, 3-carbolinyl, phenanthridinyl, acridinyl, perimidinyl, phenanthrolinyl, furazanyl, phenazinyl, phenothiazinyl, phenoxazinyl, chromenyl, isochromanyl, chromanyl and the like.

The term “heteroaryl” as used herein includes reference to an aromatic heterocyclic ring system having 5, 6, 7, 8, 9 or 10 ring atoms, at least one of which is selected from nitrogen, oxygen and sulphur. The group may be a polycyclic ring system, having two or more rings, at least one of which is aromatic, but is more often monocyclic. This term includes reference to groups such as pyrimidinyl, furanyl, benzo[b]thiophenyl, thiophenyl, pyrrolyl, imidazolyl, pyrrolidinyl, pyridinyl, benzo[b]furanyl, pyrazinyl, purinyl, indolyl, benzimidazolyl, quinolinyl, phenothiazinyl, triazinyl, phthalazinyl, 2H-chromenyl, oxazolyl, isoxazolyl, thiazolyl, isoindolyl, indazolyl, purinyl, isoquinolinyl, quinazolinyl, pteridinyl and the like.

The term “halogen” or “halo” as used herein includes reference to F, Cl, Br or I. In a particular, halogen may be F or Cl, of which Cl is more common.

The term “substituted” as used herein in reference to a moiety means that one or more, especially up to 5, more especially 1, 2 or 3, of the hydrogen atoms in said moiety are replaced independently of each other by the corresponding number of the described substituents. The term “optionally substituted” as used herein means substituted or unsubstituted.

It will, of course, be understood that substituents are only at positions where they are chemically possible, the person skilled in the art being able to decide (either experimentally or theoretically) without inappropriate effort whether a particular substitution is possible. For example, amino or hydroxy groups with free hydrogen may be unstable if bound to carbon atoms with unsaturated (e.g. olefinic) bonds. Additionally, it will of course be understood that the substituents described herein may themselves be substituted by any substituent, subject to the aforementioned restriction to appropriate substitutions as recognised by the skilled person.

### Compounds of the Invention

As discussed hereinbefore, the present invention provides a compound of the formula I shown below:

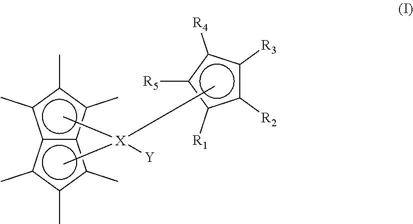

wherein
R₁ and R₂ are each independently hydrogen or linear (1-4C)alkyl, or R₁ and R₂ are linked such that, when taken in combination with the atoms to which they are attached, they form a 6-membered fused aromatic ring optionally substituted with one or more groups selected from (1-6C)alkyl, (2-6C)alkenyl, (2-6C)alkynyl, (1-6C)alkoxy, aryl, heteroaryl, carbocyclic and heterocyclic, wherein each aryl, heteroaryl, carbocyclic and heterocyclic group is optionally substituted with one or more groups selected from (1-6C)alkyl, (2-6C)alkenyl, (2-6C)alkynyl, (1-6C)alkoxy, halo, amino, nitro, cyano, (1-6C)alkylamino, [(1-6C)alkyl]₂amino and —S(O)₂(1-6C)alkyl;
R₃ and R₄ are each independently hydrogen or linear (1-4C)alkyl, or R₃ and R₄ are linked such that, when taken in combination with the atoms to which they are attached, they form a 6-membered fused aromatic ring optionally substituted with one or more groups selected from (1-6C)alkyl, (2-6C)alkenyl, (2-6C)alkynyl, (1-6C)alkoxy, aryl, heteroaryl, carbocyclic and heterocyclic, wherein each aryl, heteroaryl, carbocyclic and heterocyclic group is optionally substituted with one or more groups selected from (1-6C)alkyl, (2-6C)alkenyl, (2-6C)alkynyl, (1-6C)alkoxy, halo, amino, nitro, cyano, (1-6C)alkylamino, [(1-6C)alkyl]₂amino and —S(O)₂(1-6C)alkyl;
R₅ is hydrogen or linear (1-4C)alkyl;
X is selected from zirconium or hafnium; and
Y is selected from halo, hydride, amide, a phosphonated, sulfonated or borate anion, or a (1-6C)alkyl, (2-6C)alkenyl, (2-6C)alkynyl, (1-6C)alkoxy, —C(O)NRₐR_{b}, —NRₐR_{b}, aryl or aryloxy group which is optionally substituted with one or more groups selected from halo, (1-4C)alkyl, nitro, —NRₐR_{b}, phenyl, (1-6C)alkoxy, —C(O)NRₐR_{b}, or Si[(1-4C)alkyl]₃;
   wherein Rₐ and R^{b} are independently hydrogen or (1-4C)alkyl;

with the proviso that the compound is not one of the following:

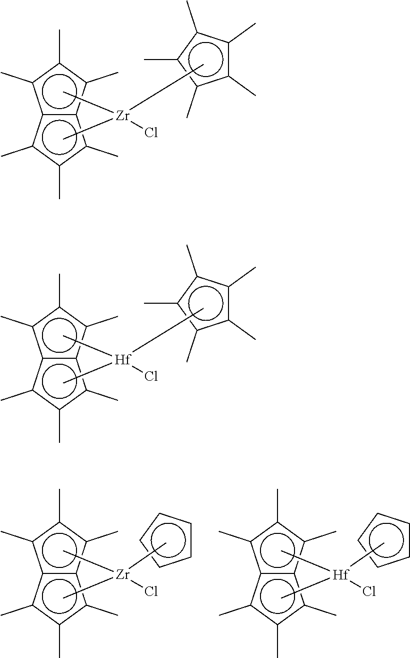

The compounds of the invention exhibit superior catalytic performance than currently available permethylpentalene metallocene olefin polymerization complexes. In particular, when compared with currently available permethylpentalene metallocene compounds used in the polymerisation of α-olefins, the compounds of the invention exhibit increased catalytic activity.

In an embodiment, at least one of R₁, R₂, R₃, R₄ and R₅ is a group other than H.

In an embodiment, R₁, R₂, R₃, R₄ and R₅ are not all methyl.

In another embodiment, R₁ and R₂ are each independently hydrogen or linear (1-4C)alkyl, or R₁ and R₂ are linked such that, when taken in combination with the atoms to which they are attached, they form a 6-membered fused aromatic ring optionally substituted with one or more groups selected from (1-6C)alkyl, (2-6C)alkenyl, (2-6C)alkynyl, (1-6C)alkoxy, aryl, heteroaryl, carbocyclic and heterocyclic, wherein each aryl, heteroaryl, carbocyclic and heterocyclic group is optionally substituted with one or more groups selected from (1-6C)alkyl, (2-6C)alkenyl, (2-6C)alkynyl, (1-6C)alkoxy and halo.

Suitably, R₁ and R₂ are each independently hydrogen or linear (1-4C)alkyl, or R₁ and R₂ are linked such that, when taken in combination with the atoms to which they are attached, they form a 6-membered fused aromatic ring optionally substituted with one or more groups selected from (1-6C)alkyl, (2-6C)alkenyl, (2-6C)alkynyl, (1-6C)alkoxy, aryl or heteroaryl, wherein each aryl or heteroaryl group is optionally substituted with one or more groups selected from (1-6C)alkyl, (2-6C)alkenyl, (2-6C)alkynyl, (1-6C)alkoxy and halo.

More suitably, R₁ and R₂ are each independently hydrogen or linear (1-4C)alkyl, or R₁ and R₂ are linked such that, when taken in combination with the atoms to which they are attached, they form a 6-membered fused aromatic ring optionally substituted with one or more groups selected from (1-4C)alkyl, (2-4C)alkenyl, (2-4C)alkynyl, (1-4C)alkoxy, aryl or heteroaryl, wherein each aryl or heteroaryl group is optionally substituted with one or more groups selected from (1-4C)alkyl, (2-4C)alkenyl, (2-4C)alkynyl, (1-4C)alkoxy and halo.

Even more suitably, R₁ and R₂ are each independently hydrogen or linear (1-4C)alkyl, or R₁ and R₂ are linked such that, when taken in combination with the atoms to which they are attached, they form a 6-membered fused aromatic ring.

Even more suitably, R₁ and R₂ are each independently hydrogen, methyl or n-butyl, or R₁ and R₂ are linked such that, when taken in combination with the atoms to which they are attached, they form a 6-membered fused aromatic ring.

In another embodiment, R₃ and R₄ are each independently hydrogen or linear (1-4C)alkyl, or R₁ and R₂ are linked such that, when taken in combination with the atoms to which they are attached, they form a 6-membered fused aromatic ring optionally substituted with one or more groups selected from (1-6C)alkyl, (2-6C)alkenyl, (2-6C)alkynyl, (1-6C)alkoxy, aryl, heteroaryl, carbocyclic and heterocyclic, wherein each aryl, heteroaryl, carbocyclic and heterocyclic group is optionally substituted with one or more groups selected from (1-6C)alkyl, (2-6C)alkenyl, (2-6C)alkynyl, (1-6C)alkoxy and halo.

Suitably, R₃ and R₄ are each independently hydrogen or linear (1-4C)alkyl, or R₁ and R₂ are linked such that, when taken in combination with the atoms to which they are attached, they form a 6-membered fused aromatic ring optionally substituted with one or more groups selected from (1-6C)alkyl, (2-6C)alkenyl, (2-6C)alkynyl, (1-6C)alkoxy, aryl or heteroaryl, wherein each aryl or heteroaryl group is optionally substituted with one or more groups selected from (1-6C)alkyl, (2-6C)alkenyl, (2-6C)alkynyl, (1-6C)alkoxy and halo.

More suitably, R₃ and R₄ are each independently hydrogen or linear (1-4C)alkyl, or R₁ and R₂ are linked such that, when taken in combination with the atoms to which they are attached, they form a 6-membered fused aromatic ring optionally substituted with one or more groups selected from (1-4C)alkyl, (2-4C)alkenyl, (2-4C)alkynyl, (1-4C)alkoxy, aryl or heteroaryl, wherein each aryl or heteroaryl group is optionally substituted with one or more groups selected from (1-4C)alkyl, (2-4C)alkenyl, (2-4C)alkynyl, (1-4C)alkoxy and halo.

Even more suitably, R₃ and R₄ are each independently hydrogen or linear (1-4C)alkyl, or R₁ and R₂ are linked such that, when taken in combination with the atoms to which they are attached, they form a 6-membered fused aromatic ring.

Even more suitably, R₃ and R₄ are each independently hydrogen, methyl or n-butyl, or R₃ and R₄ are linked such that, when taken in combination with the atoms to which they are attached, they form a 6-membered fused aromatic ring.

In another embodiment, R₅ is hydrogen, methyl or n-butyl.

In another embodiment, R₅ is hydrogen or methyl. Suitably, R₅ is hydrogen.

In another embodiment, X is zirconium.

Y is selected from halo, hydride, amide, a phosphonated, sulfonated or borate anion, or a (1-6C)alkyl, (2-6C)alkenyl, (2-6C)alkynyl, (1-6C)alkoxy, —C(O)NRₐR_{b}, —NRₐR_{b}, aryl or aryloxy group which is optionally substituted with one or more groups selected from halo, (1-4C)alkyl, nitro, —NRₐR_{b}, phenyl, (1-6C)alkoxy, —C(O)NRₐR_{b}, or Si[(1-4C)alkyl]₃. Suitably, Y is —NRₐR_{b}, wherein Rₐ and R_{b} are both hydrogen and are both substituted with phenyl to yield a group —N(C₆H₅)₂.

In another embodiment, Y is selected from halo, hydride, amide, a phosphonated, sulfonated or borate anion, or a (1-6C)alkyl, (2-6C)alkenyl, (2-6C)alkynyl, (1-6C)alkoxy, —NRₐR_{b}, aryl or aryloxy group which is optionally substituted with one or more groups selected from halo, (1-4C)alkyl and phenyl.

In another embodiment, Y is selected from halo, hydride, a phosphonated, sulfonated or borate anion, or a (1-6C)alkyl, (2-6C)alkenyl, (2-6C)alkynyl, (1-6C)alkoxy, —NRₐR_{b}, aryl or aryloxy group which is optionally substituted with one or more groups selected from halo, (1-4C)alkyl and phenyl.

Suitably, Y is selected from halo, hydride, or a (1-6C)alkyl, (2-6C)alkenyl, (2-6C)alkynyl, (1-6C)alkoxy, —NRₐR_{b}, aryl or aryloxy group which is optionally substituted with one or more groups selected from halo, (1-4C)alkyl and phenyl.

More suitably, Y is selected from halo, hydride, or a (1-4C)alkyl, (1-5C)alkoxy, —NRₐR_{b}, aryl or aryloxy group which is optionally substituted with one or more groups selected from halo, (1-4C)alkyl and phenyl.

Even more suitably, Y is halo, hydride, methyl, n-butyl, —N(CH₃)₂, —N(C₆H₅)₂, —O-2,6-dimethyl-C₆H₃), —O-2,6-diisopropyl-C₆H₃), —O-2,4-ditertbutyl-C₆H₃), —O—C(CH₃)₂CH₂CH₃.

Yet more suitably, Y is Cl or methyl. Most suitably, Y is methyl.

In another embodiment, Y is selected from halo, hydride, a phosphonated, sulfonated or borate anion, or a (1-6C)alkyl, (2-6C)alkenyl, (2-6C)alkynyl, (1-6C)alkoxy, aryl or aryloxy group which is optionally substituted with one or more groups selected from halo and (1-4C)alkyl.

Suitably, Y is selected from halo, hydride, or a (1-6C)alkyl, (2-6C)alkenyl, (2-6C)alkynyl, (1-6C)alkoxy, aryl or aryloxy group which is optionally substituted with one or more groups selected from halo and (1-4C)alkyl.

More suitably, Y is selected from halo, hydride, or a (1-4C)alkyl, (2-4C)alkenyl, (2-4C)alkynyl, (1-4C)alkoxy, aryl or aryloxy group which is optionally substituted with one or more groups selected from halo and (1-4C)alkyl.

Even more suitably, Y is halo. Yet more suitably, Y is Cl, Br or I. Most suitably, Y is Cl.

In another embodiment, the compound of formula I has a structure according to formula Ia, Ib, or Ic shown below:

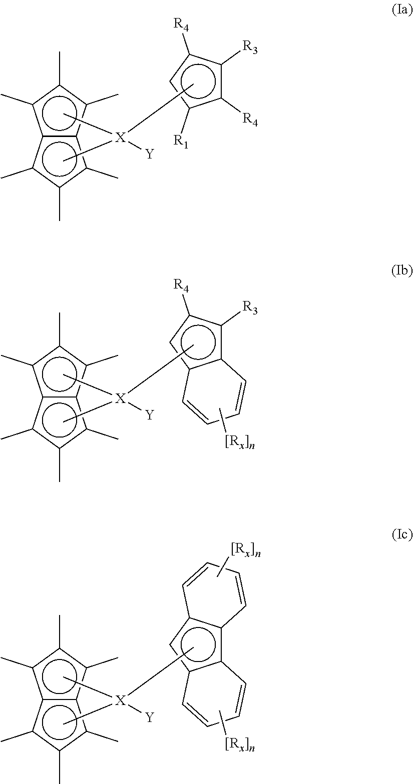

wherein,

R₁ and R₂ are each independently hydrogen or linear (1-4C)alkyl

R₃ and R₄ are each independently hydrogen or linear (1-4C)alkyl

each Rₓ is independently selected from (1-6C)alkyl, (2-6C)alkenyl, (2-6C)alkynyl, (1-6C)alkoxy, aryl, heteroaryl, carbocyclic and heterocyclic, wherein each aryl, heteroaryl, carbocyclic and heterocyclic group is optionally substituted with one or more groups selected from (1-6C)alkyl, (2-6C)alkenyl, (2-6C)alkynyl, (1-6C)alkoxy, halo, amino, nitro, cyano, (1-6C)alkylamino, [(1-6C)alkyl]₂amino and —S(O)₂(1-6C)alkyl;

each n is independently an integer selected from 0, 1, 2, 3, or 4;

X is Zr or Hf; and

Y is selected from halo, hydride, a phosphonated, sulfonated or borate anion, or a (1-6C)alkyl, (2-6C)alkenyl, (2-6C)alkynyl, (1-6C)alkoxy, —C(O)NRₐR_{b}, —NRₐR_{b}, aryl or aryloxy group which is optionally substituted with one or more groups selected from halo, (1-4C)alkyl, nitro, NRₐR_{b}, phenyl, (1-6C)alkoxy, —C(O)NRₐR_{b}, or Si[(1-4C)alkyl]₃
wherein Rₐ and R_{b} are independently hydrogen or (1-4C)alkyl;

with the proviso that the compound is not one of the following:

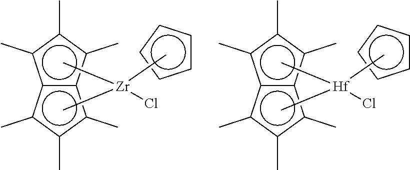

In another embodiment, the compound of formula I has a structure according to formula Ia, Ib or Ic, with the proviso that at least one of R₁, R₂, R₃ and R₄ is a group other than H

In another embodiment, the compound of formula I has a structure according to formula Ia, Ib or Ic, wherein

each Rₓ is independently selected from (1-6C)alkyl, (2-6C)alkenyl, (2-6C)alkynyl and (1-6C)alkoxy; and

each n is independently an integer selected from 0, 1, or 2.

In another embodiment, the compound of formula I has a structure according to formula Ia, Ib or Ic, wherein

X is Zr; and

Y is selected from halo, hydride, or a (1-6C)alkyl, (2-6C)alkenyl, (2-6C)alkynyl, (1-6C)alkoxy, NRₐR_{b}, aryl or aryloxy group which is optionally substituted with one or more groups selected from halo, (1-4C)alkyl or phenyl;

wherein Rₐ and R_{b} are independently hydrogen or methyl.

In another embodiment, the compound of formula I has a structure according to formula Ia, Ib or Ic, wherein

R₁ and R₂ are each independently hydrogen or linear (1-2C)alkyl;

R₃ and R₄ are each independently hydrogen or linear (1-2C)alkyl;

each Rₓ is independently selected from (1-3C)alkyl, (2-3C)alkenyl, (2-3C)alkynyl and (1-3C)alkoxy;

each n is independently an integer selected from 0, 1 or 2;

X is Zr; and

Y is selected from halo, hydride, or a (1-6C)alkyl, (1-5C)alkoxy or aryloxy group which is optionally substituted with one or more groups selected from halo or (1-4C)alkyl, or Y is a group —N(CH₃)₂ or —N(C₆H₅)₂.

In another embodiment, the compound of formula I has a structure according to formula Ia, Ib or Ic, wherein

R₁ and R₂ are each independently hydrogen or linear (1-4C)alkyl;

R₃ and R₄ are each independently hydrogen or linear (1-4C)alkyl;

n is 0;

X is Zr or Hf; and

Y is selected from halo, hydride, or a (1-6C)alkyl, (1-5C)alkoxy, or aryloxy group which is optionally substituted with one or more groups selected from halo or (1-4C)alkyl, or Y is a group —N(CH₃)₂ or —N(C₆H₅)₂.

In another embodiment, the compound of formula I has a structure according to formula Ia, Ib or Ic, wherein

R₁ and R₂ are each independently hydrogen or (1-2C)alkyl;

R₃ and R₄ are each independently hydrogen or (1-2C)alkyl;

n is 0;

X is Zr or Hf; and

Y is selected from halo, hydride, or a (1-6C)alkyl or aryloxy group which is optionally substituted with one or more groups selected from halo or (1-4C)alkyl, or Y is a group —N(CH₃)₂ or —N(C₆H₅)₂.

In another embodiment, the compound of formula I has a structure according to formula Ia, Ib or Ic, wherein

R₁ and R₂ are each independently hydrogen, methyl or n-butyl;

R₃ and R₄ are each independently hydrogen, methyl or n-butyl;

n is 0;

X is Zr or Hf; and

Y is selected from halo, hydride, or a (1-6C)alkyl (e.g. methyl or n-butyl) or aryloxy group which is optionally substituted with one or more groups selected from halo or (1-4C)alkyl, or Y is a group —N(CH₃)₂ or —N(C₆H₅)₂.

In another embodiment, the compound of formula I has a structure according to formula Id, Ie or If shown below:

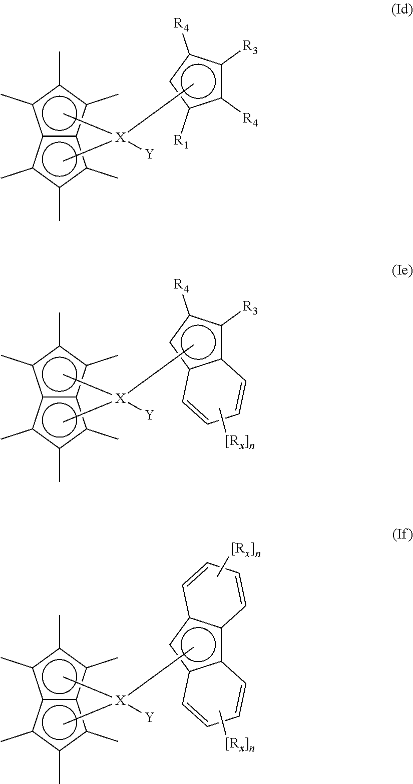

wherein,

R₁ and R₂ are each independently hydrogen or linear (1-4C)alkyl

R₃ and R₄ are each independently hydrogen or linear (1-4C)alkyl

each Rₓ is independently selected from (1-6C)alkyl, (2-6C)alkenyl, (2-6C)alkynyl, (1-6C)alkoxy, aryl, heteroaryl, carbocyclic and heterocyclic, wherein each aryl, heteroaryl, carbocyclic and heterocyclic group is optionally substituted with one or more groups selected from (1-6C)alkyl, (2-6C)alkenyl, (2-6C)alkynyl, (1-6C)alkoxy, halo, amino, nitro, cyano, (1-6C)alkylamino, [(1-6C)alkyl]₂amino and —S(O)₂(1-6C)alkyl;

each n is independently an integer selected from 0, 1, 2, 3, or 4;

X is Zr or Hf; and

Y is selected from halo, hydride, a phosphonated, sulfonated or borate anion, or a (1-6C)alkyl, (2-6C)alkenyl, (2-6C)alkynyl, (1-6C)alkoxy, —C(O)NRₐR_{b}, —NRₐR_{b}, aryl or aryloxy group which is optionally substituted with one or more groups selected from halo, (1-4C)alkyl, nitro, NRₐR_{b}, phenyl, (1-6C)alkoxy, —C(O)NRₐR_{b}, or Si[(1-4C)alkyl]₃
wherein Rₐ and R_{b} are independently hydrogen or (1-4C)alkyl;

with the proviso that at least one of R₁, R₂, R₃ and R₄ is a group other than H.

In another embodiment, the compound of formula I has a structure according to formula Id, Ie or If, wherein

each Rₓ is independently selected from (1-6C)alkyl, (2-6C)alkenyl, (2-6C)alkynyl and (1-6C)alkoxy; and

each n is independently an integer selected from 0, 1, or 2.

In another embodiment, the compound of formula I has a structure according to formula Id, Ie or If, wherein

X is Zr; and

Y is selected from halo, hydride, or a (1-6C)alkyl, (2-6C)alkenyl, (2-6C)alkynyl, (1-6C)alkoxy, aryl or aryloxy group which is optionally substituted with one or more groups selected from halo or (1-4C)alkyl.

In another embodiment, the compound of formula I has a structure according to formula Id, Ie or If, wherein

R₁ and R₂ are each independently hydrogen or linear (1-2C)alkyl;

R₃ and R₄ are each independently hydrogen or linear (1-2C)alkyl;

each Rₓ is independently selected from (1-3C)alkyl, (2-3C)alkenyl, (2-3C)alkynyl and (1-3C)alkoxy;

each n is independently an integer selected from 0, 1 or 2;

X is Zr; and

Y is selected from halo, hydride, or a (1-6C)alkyl or aryloxy group which is optionally substituted with one or more groups selected from halo or (1-4C)alkyl.

In another embodiment, the compound of formula I has a structure according to formula Id, Ie or If, wherein

R₁ and R₂ are each independently hydrogen or linear (1-4C)alkyl;

R₃ and R₄ are each independently hydrogen or linear (1-4C)alkyl;

n is 0;

X is Zr or Hf; and

Y is selected from halo, hydride, or a (1-6C)alkyl or aryloxy group which is optionally substituted with one or more groups selected from halo or (1-4C)alkyl.

In another embodiment, the compound of formula I has a structure according to formula Id, Ie or If, wherein

R₁ and R₂ are each independently hydrogen or (1-2C)alkyl;

R₃ and R₄ are each independently hydrogen or (1-2C)alkyl;

n is 0;

X is Zr or Hf; and

Y is selected from halo, hydride, or a (1-6C)alkyl or aryloxy group which is optionally substituted with one or more groups selected from halo or (1-4C)alkyl.

In another embodiment, the compound of formula I has a structure according to formula Id, Ie or If, wherein

R₁ and R₂ are each independently hydrogen or methyl;

R₃ and R₄ are each independently hydrogen or methyl;

n is 0;

X is Zr or Hf; and

Y is selected from halo, hydride, or a (1-6C)alkyl or aryloxy group which is optionally substituted with one or more groups selected from halo or (1-4C)alkyl.

In an embodiment, the compound of formula I has any one of the following structures:

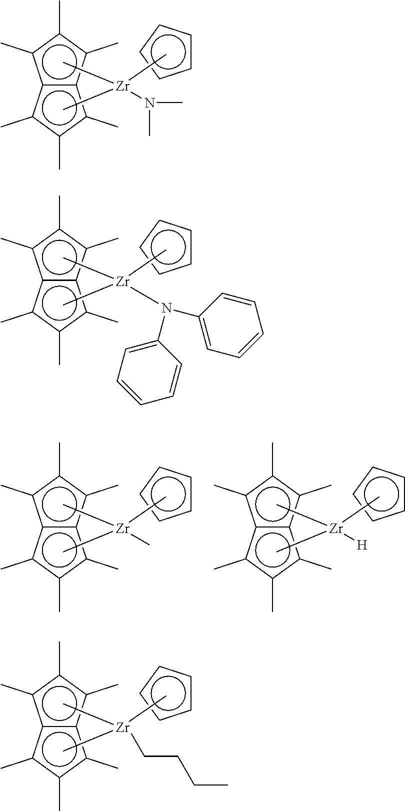

In a particular embodiment, the compound of formula I has any one of the following structures:

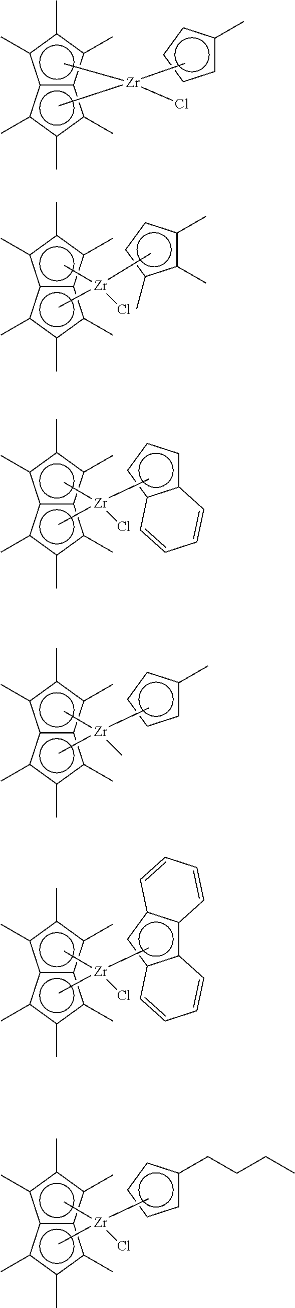

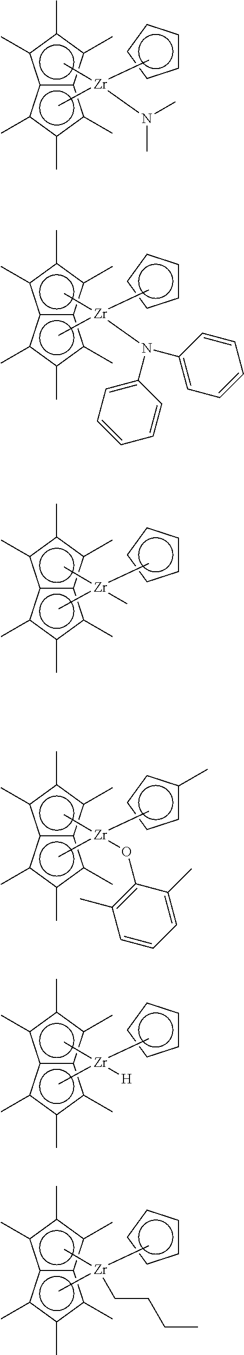

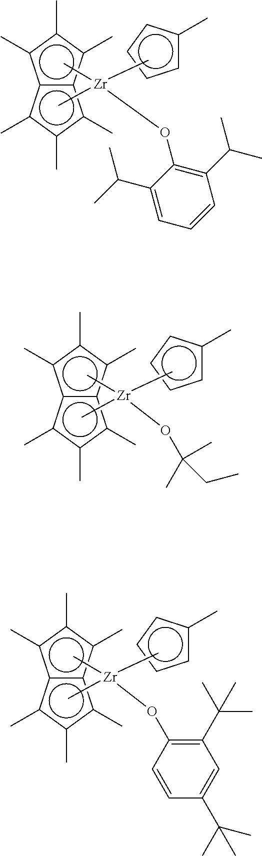

In another particular embodiment, the compound of formula I has any one of the following structures:

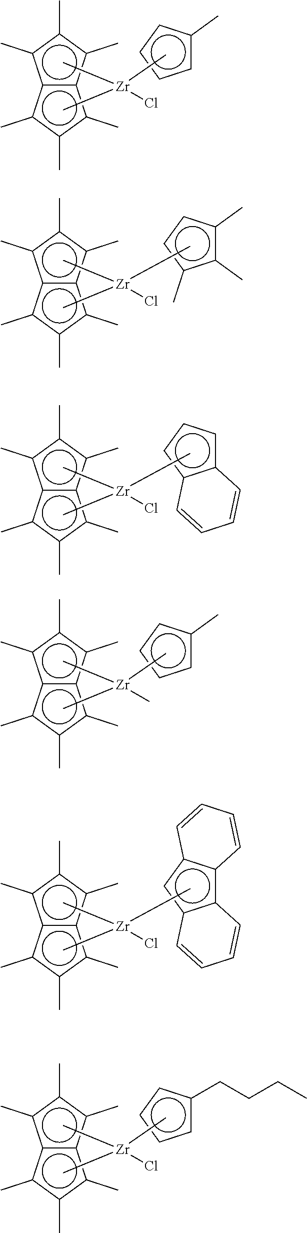

In another particular embodiment, the compound of formula I has any one of the following structures:

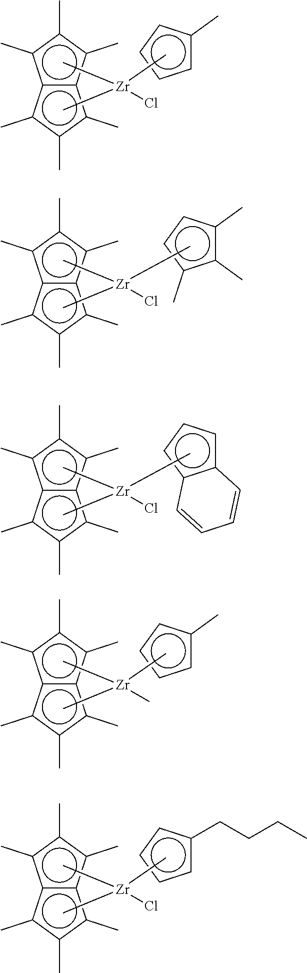

In another particular embodiment, the compound of formula I has any one of the following structures:

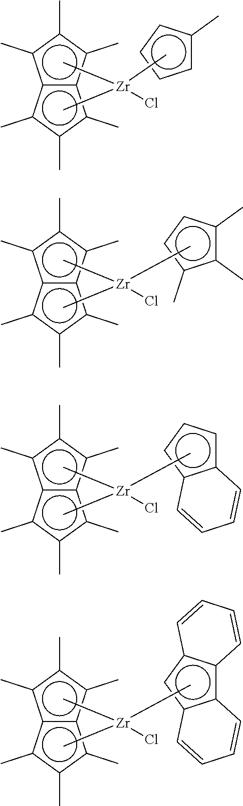

In another particular embodiment, the compound of formula I has the structure:

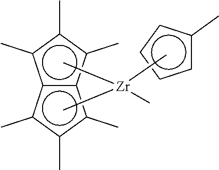

### Synthesis

The compounds of the present invention may be synthesised by any suitable process known in the art. Particular examples of processes for preparing compounds of the present invention are set out in the accompanying examples.

Suitably, compounds of the present invention are prepared according to Scheme 1 below.

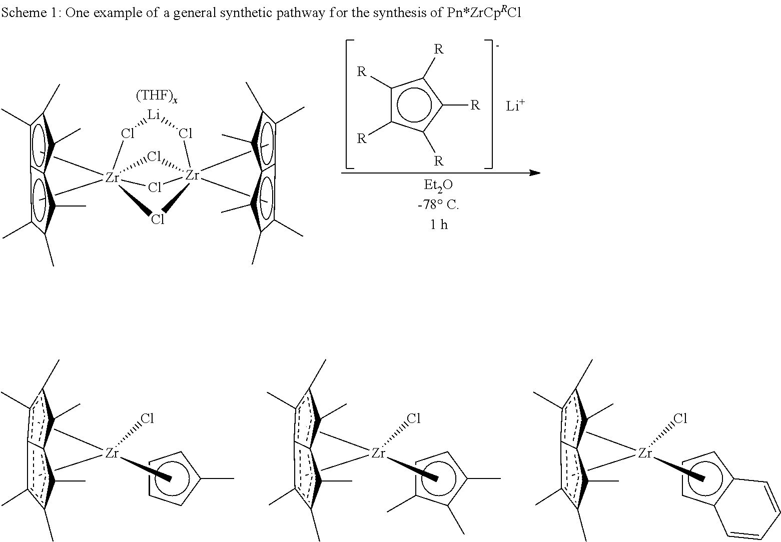

Having regard to Scheme 1 above, it will be understood that the five “R” groups respectively have definitions according to R₁, R₂, R₃, R₄ and R₅ defined herein. It will be appreciated that “Cl” is only one example of a Y group defined herein, and that the skilled person will readily appreciate how Cl can be exchanged for other Y groups defined herein. Similarly, it will be appreciated that “Li” may be exchanged for an alternative metal. Any suitable solvent may be used. Where necessary, a person of skill in the art will be able to select suitable reaction conditions (e.g. temperature, pressures, reaction times, agitation etc.) for such syntheses.

Exemplary synthetic routes for obtaining other compounds encompassed by the present invention are outlined in Schemes 2-8 below.

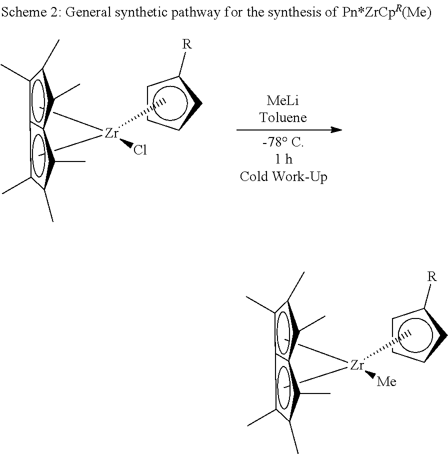

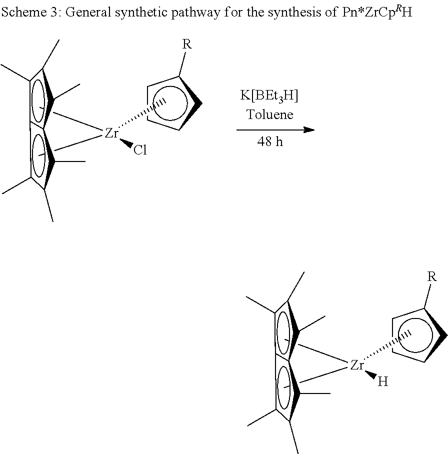

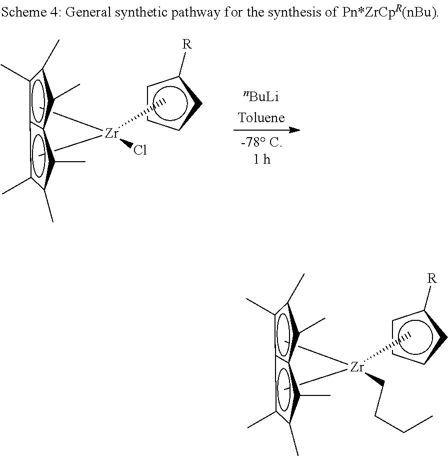

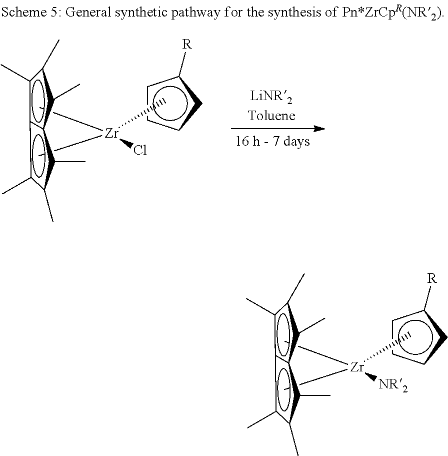

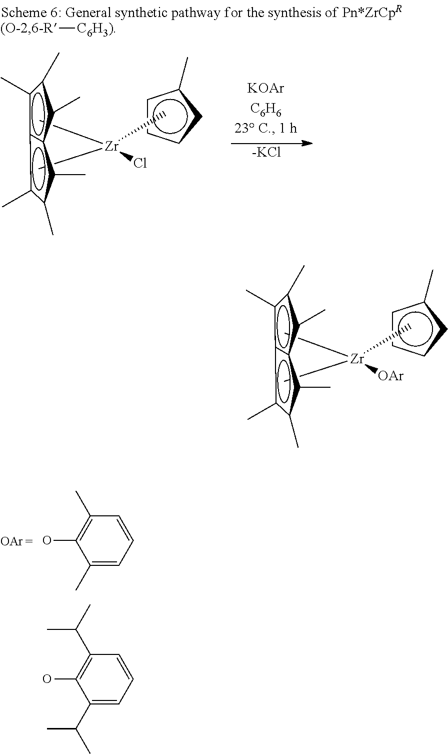

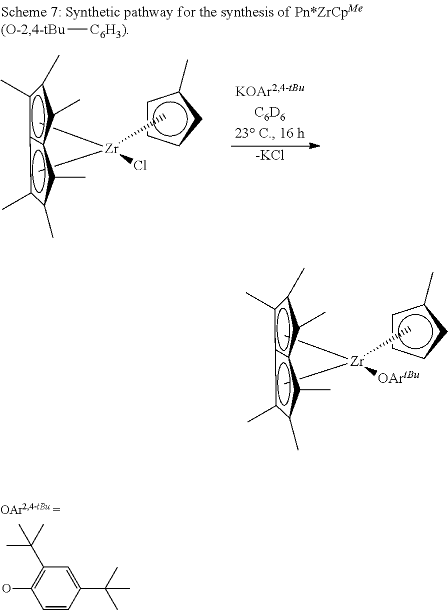

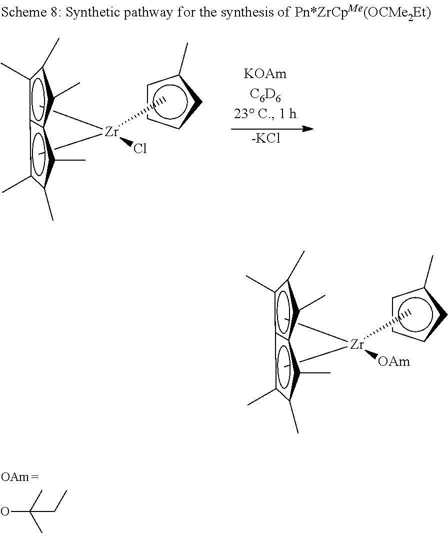

### Compositions

As discussed hereinbefore, the present invention also provides a composition comprising a compound of formula I defined herein and at least one suitable activator.

Suitable activators are well known in the art and include organo aluminium compounds (e.g. alkyl aluminium compounds). Particularly suitable activators include aluminoxanes (e.g. methylaluminoxane (MAO)), triisobutylaluminium (TIBA), diethylaluminium (DEAC) and triethylaluminium (TEA).

In another embodiment, the compound of formula I may be associated with (e.g. immobilized on) a suitable support. The nature of the association may be ionic or covalent, via one or more bonds. Suitably, the support is insoluble under the polymerisation conditions. Examples of suitable supports include silicas, layered-double hydroxides (LDH, e.g. AMO-LDH MgAl—CO₃), and any other inorganic support material. Supports such as silica and AMO-LDH may be subjected to a heat treatment prior to use. An exemplary heat treatment involves heating the support to 400-600° C. (for silicas) or 100-150° C. (for AMO-LDHs) in a nitrogen atmosphere. An exemplary layered double hydroxide is [Mg₁₋ₓAlₓ(OH)₂]^{x+}(Aⁿ⁻)_{x/n}.y(H₂O).w(solvent), in which 0.1<x>0.9; A=anion eg. CO₃²⁻, OH⁻, F⁻, Br⁻, I⁻, SO₄²⁻, NO₃⁻ and PO₄³⁻; w is a number less than 1; y is 0 or a number greater than 0 which gives compounds optionally hydrated with a stoichiometric amount or a non-stoichiometric amount of water and/or an aqueous-miscible organic solvent (AMO-solvent), such as acetone.

Suitably, the support is an activated support. The support may be activated by the presence of a suitable activator being covalently bound to the support. Suitably activators include organo aluminium compounds (e.g. alkyl aluminium compounds), in particular methyl aluminiumoxane. Examples of activated supports include methylaluminoxane activated silica (otherwise known as MAO-modified silica or silica supported MAO (ssMAO)) and methylaluminoxane activated layered double hydroxide (otherwise known as MAO-modified LDH or LDH-MAO). When the support is an activated support, it will be understood that the activated support is the at least one suitable activator.

In an embodiment, the compound of formula I is supported on ssMAO or LDH-MAO, wherein the molar ratio of compound of formula I to ssMAO or LDH-MAO (defined herein as [Zr]:[Al]) is 1:(50-300) (e.g. 1:100 or 1:250). Suitably, the molar ratio of compound of formula I to ssMAO or LDH-MAO (defined herein as [Zr]:[Al]) is 1:(75-125).

In another embodiment, the activated support may comprise an additional (separate) activator being an organo aluminium compound (e.g. alkyl aluminium compound). Suitably, the additional activator is triisobutylaluminium (TIBA). The additional (separate) activator may take the form of a species capable of scavenging one or more of oxygen, water and other protic impurities.

### Applications

As discussed hereinbefore, the compounds of the invention are effective catalysts/initiators in the polymerisation of olefins.

Thus, as discussed hereinbefore, the present invention also provides a use of a compound of formula I defined herein, or a composition defined herein, in the polymerisation of olefins.

In one embodiment, the olefins are all ethene (ethylene), thus resulting in a polyethylene homopolymer.

In another embodiment, the olefins are different, thus resulting in a copolymer. In an embodiment, the mixture of olefins contains 90-99 wt % of ethene monomers and 1-10 wt % of (4-8C) α-olefin. Suitably, the (4-8C) α-olefin is 1-butene, 1-hexene, 1-octene, or a mixture thereof.

As discussed hereinbefore, the present invention also provides a process for polymerising one or more olefins, said process comprising the step of polymerising the one or more olefins in the presence of:

(i) a compound of formula I defined herein, or a composition defined herein; and

(ii) a suitable activator.

In one embodiment, the process may be conducted in homogeneous solution.

In an alternative embodiment, the process comprises the step of polymerising the one or more olefins in the presence of compound of formula I as defined herein and a suitable activator, wherein the compound is immobilized on a suitable support, as defined herein. Suitably, the support is an activated support.

Suitably, the activated support is insoluble under the olefin polymerisation conditions, such that the process proceeds via slurry polymerisation.

In another embodiment, the olefins are ethene monomers, thus resulting in a polyethylene homopolymeric product.

In another embodiment, the olefins are a mixture of olefins, thus resulting in a copolymeric product. The mixture of olefins may contain 90-99 wt % of ethene monomers and 1-10 wt % of (4-8C) α-olefin. Suitably, the (4-8C) α-olefin is 1-butene, 1-hexene, 1-octene, or a mixture thereof.

A person skilled in the art of olefin polymerization will be able to select suitable reaction conditions (e.g. temperature, pressures, reaction times etc.) for such a polymerization reaction. A person skilled in the art will also be able to manipulate the process parameters in order to produce a polyolefin having particular properties.

In an embodiment, the process is conducted at a temperature of 40-90° C.

The suitable activator forming part of the process may have any of those definitions appearing hereinbefore in relation to the compositions of the invention. It will be appreciated that when the process is conducted in the presence of a composition as defined herein, the suitable activator forming part of the process may be inherently present within the composition itself (e.g. in the form an activated support), such that the process is conducted in the presence of only 1 type of activator. Alternatively, when the process is conducted in the presence of a composition as defined herein, the suitable activator forming part of the process may be present in addition to the activator inherently present within the composition, such that the process is in fact conducted in the presence of 2 types of activator. Such an additional activator may take the form of a species capable of scavenging one or more of oxygen, water and other protic impurities.

### EXAMPLES

Examples of the invention will now be described, for the purpose of illustration only, by reference to the accompanying figures, in which:

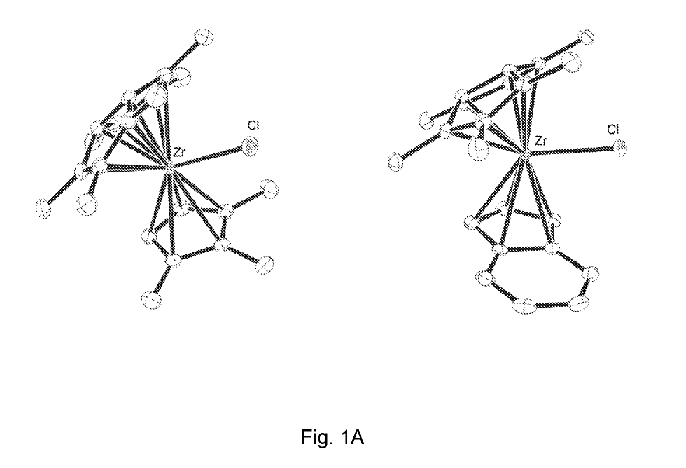

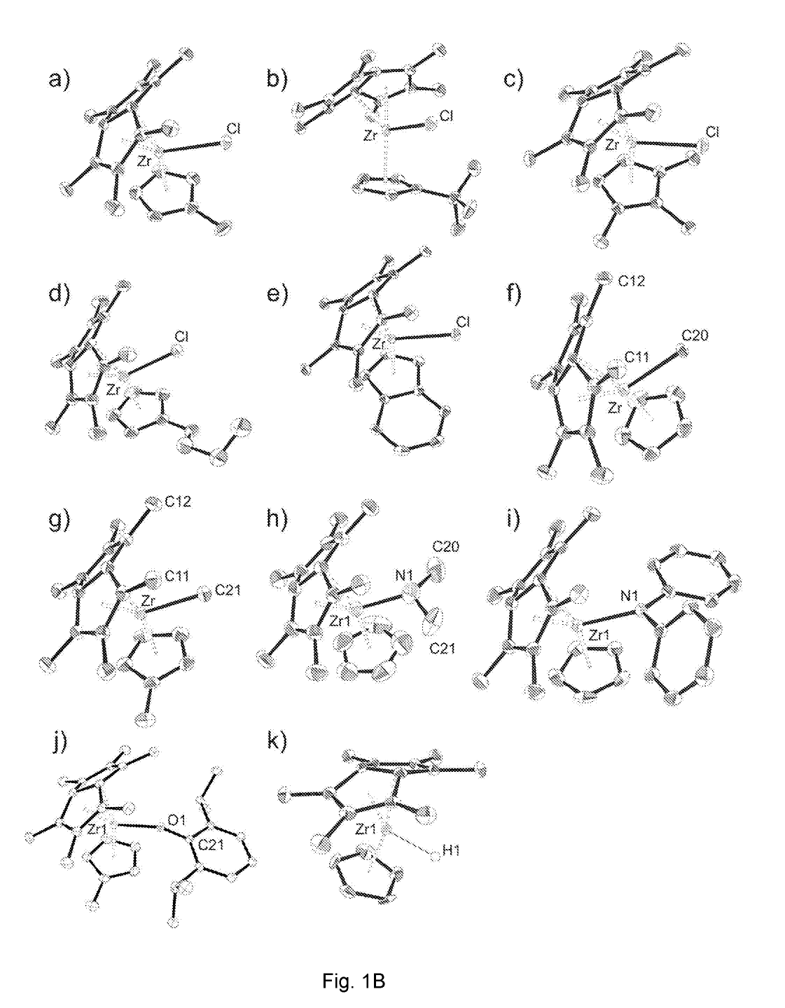

FIG. 1 shows A) the molecular structures of (left) Pn*ZrCp^{1,2,3-Me}Cl; (right) Pn*ZrIndCl as determined by X-ray crystallography. Thermal ellipsoids shown at 50% probability. B) molecular structures of a) Pn*ZrCp^{Me}Cl, b) Pn*ZrCp^{tBu}Cl, c) Pn*ZrCp^{Me}^{₃}Cl, d) Pn*ZrCp^{nBu}Cl, e) Pn*ZrIndCl, f) Pn*ZrCpMe, g) Pn*ZrCp^{Me}(Me), h) Pn*ZrCp(NMe₂), i) Pn*ZrCp(NPh₂), j) Pn*ZrCp^{Me}(O-2,6-Me-C₆H₃) and k) Pn*ZrCp(H) as determined by X-ray crystallography.

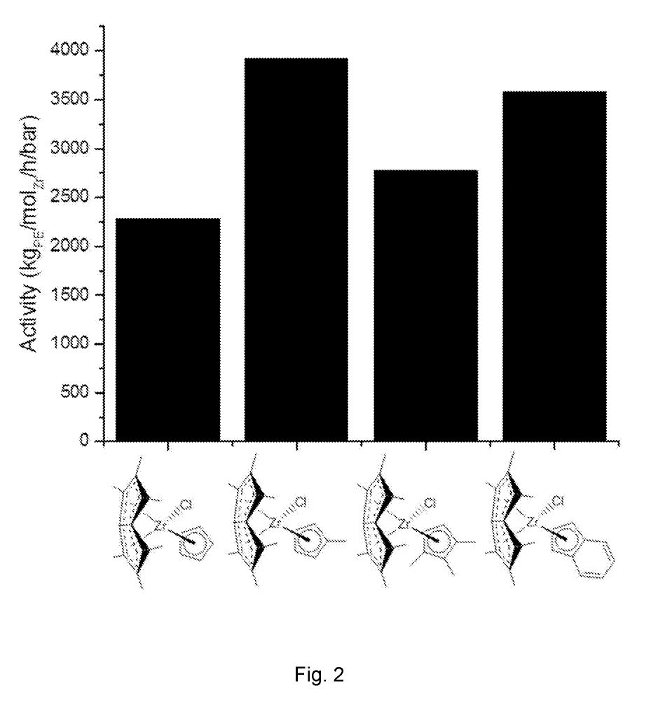

FIG. 2 shows the activity of various Pn*ZrCpRCl complexes in the solution phase polymerisation of ethylene. Polymerisation conditions [Zr]:[MAO] of 1:250, 50 mL toluene, 60° C., 2 bar and 5 minutes.

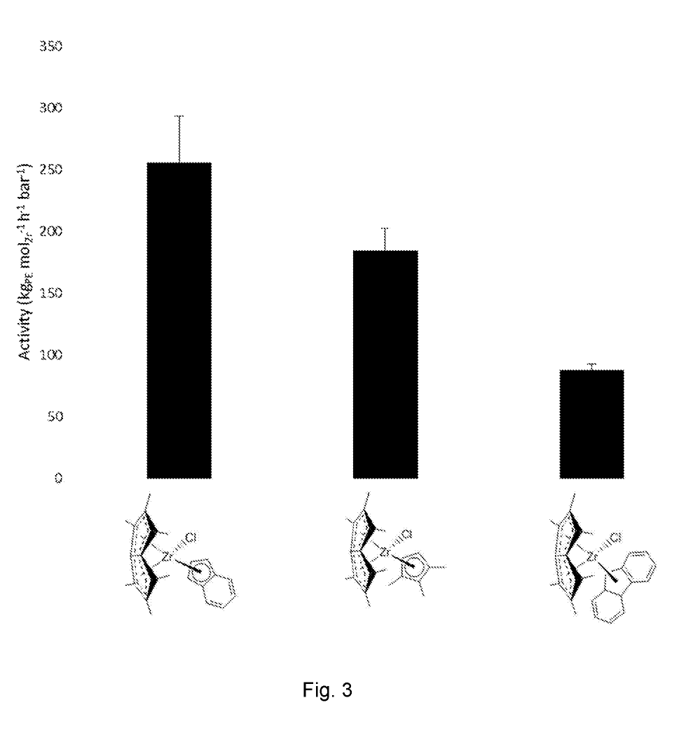

FIG. 3 shows the activity of various silica-supported Pn*ZrCp^{R}Cl complexes in the slurry phase polymerisation of ethylene. Polymerisation conditions [Zr]:[MAO] of 1:1000, 50 mL hexanes, 60° C., 2 bar and 60 minutes.

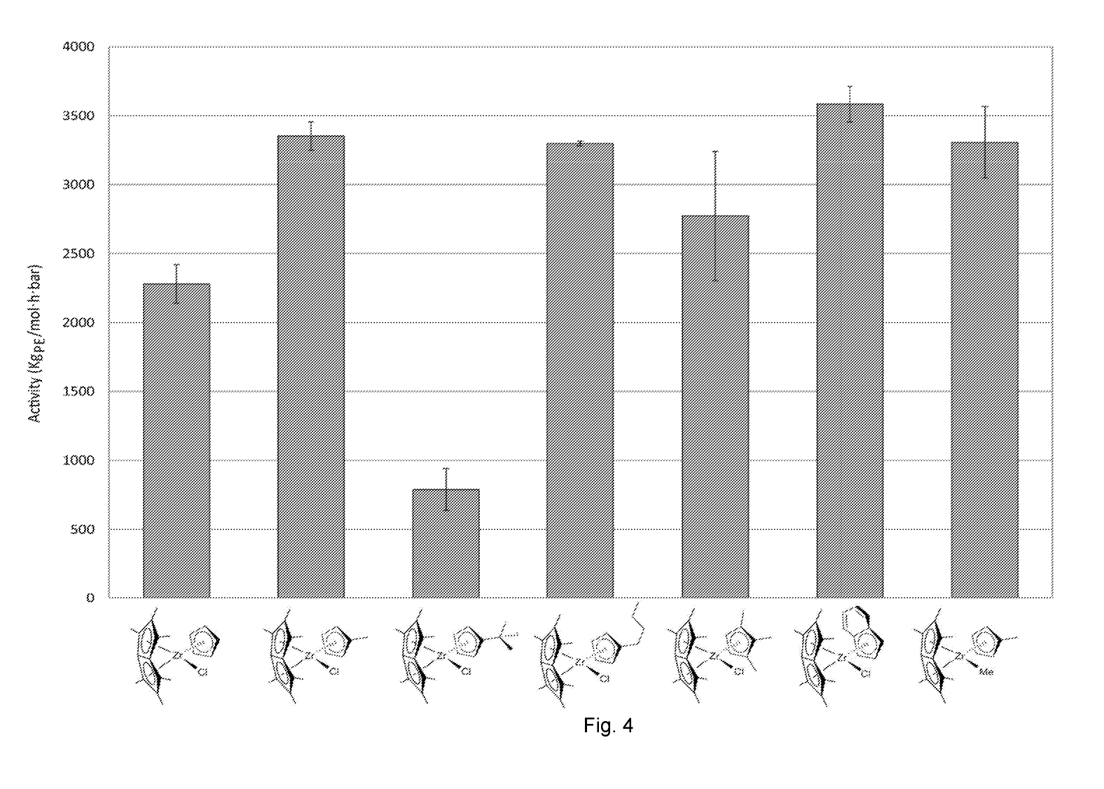

FIG. 4 shows solution phase ethylene polymerisation activities of Pn*ZrCp^{R}Cl (Cp^{R}=Cp, Cp^{Me}, Cp^{tBu}, Cp^{nBu}, Cp^{Me3}, Ind) and Pn*ZrCp^{Me}(Me). Polymerisation conditions: [Zr]:[MAO]=1:250; 2 bar ethylene; 0.5 mg catalyst loading; 50 mL toluene; 60° C.; 5 minutes.

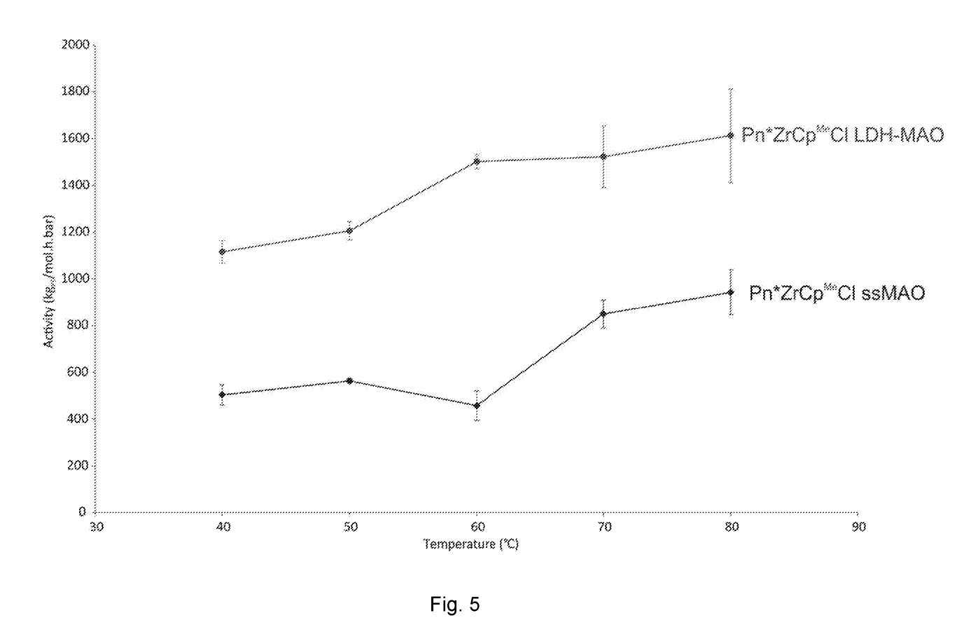

FIG. 5 shows a comparison of ethylene polymerisation activities of supported Pn*ZrCp^{Me}Cl (top to bottom): LDH-MAO, ssMAO. Slurry conditions: [Zr]:[Al]=1:200; 150 mg TiBA co-catalyst; 2 bar ethylene; 10 mg catalyst loading; 50 mL toluene; 30 minutes.

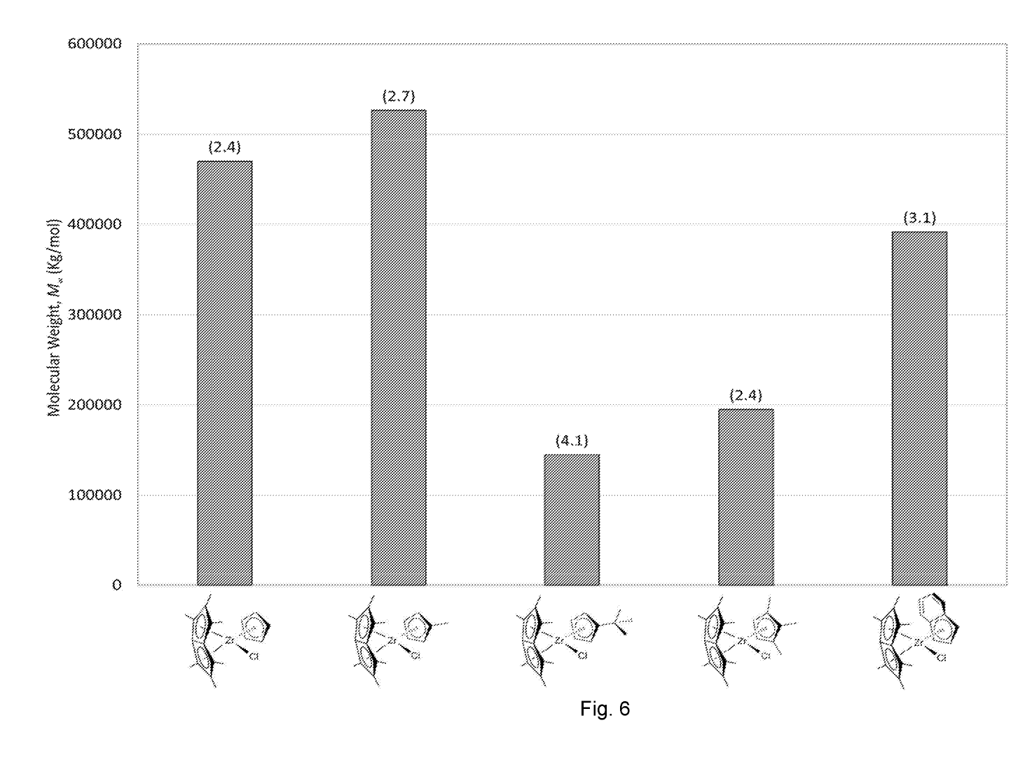

FIG. 6 shows polymer molecular weight, M_{w} for solution ethylene polymerisation at 60° C. with Pn*ZrCp^{R}Cl (Cp^{R}=Cp^{Me}, Cp^{tBu}, Cp^{Me3}, Ind) PDIs are given in parentheses. Polymerisation conditions: [Zr]:[MAO]=1:250; 2 bar ethylene; 0.5 mg catalyst loading; 50 mL toluene; 60° C.; 5 minutes.

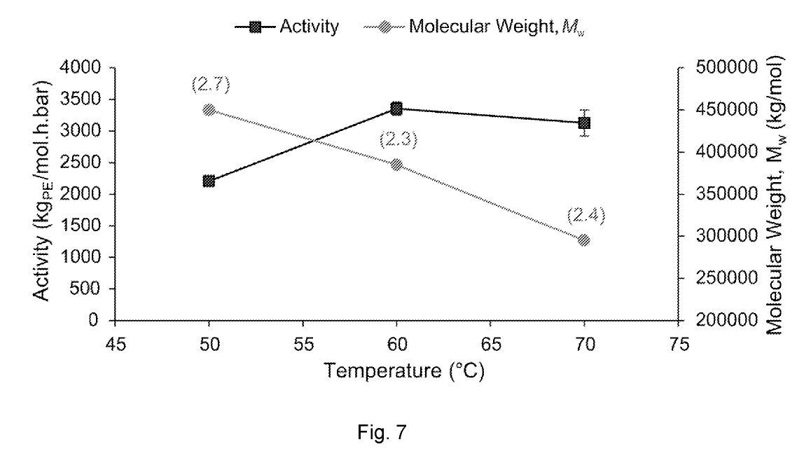

FIG. 7 shows temperature dependence of ethylene polymerisation activity and molecular weight, M_{w} with pre-catalyst Pn*ZrCp^{Me}Cl in solution phase. PDIs are given in parentheses. Polymerisation conditions: [Zr]:[MAO]=1:250; 2 bar ethylene; 0.5 mg catalyst loading; 50 mL toluene; 5 minutes.

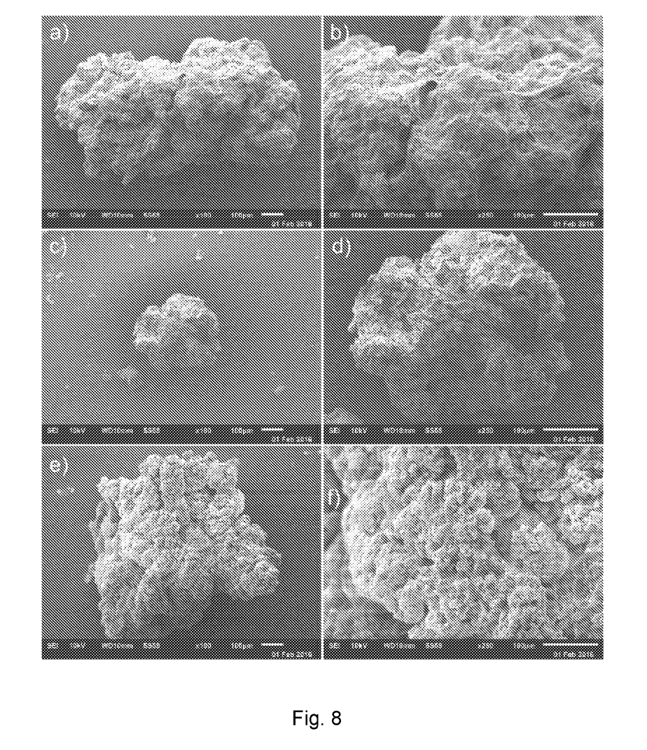

FIG. 8 shows SEM of polymer produced by solution-phase polymerisation of ethylene using a) Pn*ZrCp^{Me}Cl at ×100 magnification; b) Pn*ZrCp^{Me}Cl at ×250 magnification; c) Pn*ZrCp^{tBu}Cl at ×100 magnification; d) Pn*ZrCp^{tBu}Cl at ×250 magnification; e) Pn*ZrIndCl at ×100 magnification; and f) Pn*ZrIndCl at ×250 magnification. Polymerisation conditions: [Zr]:[MAO]=1:250; 2 bar ethylene; 0.5 mg catalyst loading; 50 mL toluene; 5 minutes.

### Example 1—Synthesis of Catalytic Compounds

### Example 1a—Synthesis of Pn*ZrCp^{Me}Cl

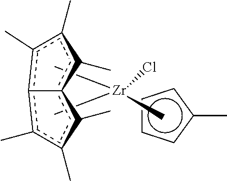

ZrPn*(μ-Cl)_{3/2}]₂(μ-Cl)₂Li.Et₂O_{(1.21)} (300 mg, 0.362 mmol) was dissolved in Et₂O (20 mL) and cooled to −78° C. Et₂O (15 mL) was added to LiCp^{Me} (62.3 mg, 0.724 mmol), cooled to −78° C. and the contents slurried onto the solution of [ZrPn*(μ-Cl)_{3/2}]₂(μ-Cl)₂Li.Et₂O_{(1.21)}. The schlenk was allowed to warm to room temperature over the course of an hour, and then stirred for a further hour. The Et₂O was then removed under vacuum, and the solids dissolved sparingly in benzene (3×2 mL) before being filtered into a small schlenk. The benzene was frozen at −78° C., removed from the cold bath, and exposed to dynamic vacuum overnight causing the solvent to sublime. The solid was then washed with −78° C. pentane (2×3 mL) and dried under vacuum for 4 h giving the product in 54% yield (152 mg, 0.388 mmol).

¹H NMR (C₆D₆) δ (ppm): 1.66 {(2,6)-Me₂, 6H, s}; 1.81 {(3,5)-Me₂, 6H, s}; 2.12 {(1,7)-Me₂, Cp-Me, 9H, s); 5.13 {Cp(2,5)-CH, 2H, t (³J_{H—H}=2.6 Hz}); 5.59 {Cp(3,4)-CH, 2H, t (³J_{H—H}=2.6 Hz))}

¹³C NMR (C₆D₆) δ (ppm): 10.8 {(2,6)-Me₂}; 12.4 {(1,7)-Me₂}; 13.0 {(3,5)-Me₂}; 14.5 (Cp-Me); 106.1 {Cp(2,5)}; 113.6 {Cp(3,4)} 124.3 (Cp(1)}

### Example 1b—Synthesis of ZrPn*Cp^{Me3}Cl

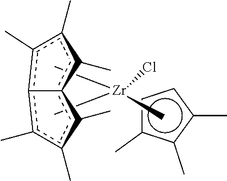

[ZrPn*(μ-Cl)_{3/2}]₂(μ-Cl)₂Li.THF_{(1.02)} (250 mg, 0.308 mmol) was dissolved in Et₂O (20 mL) and cooled to −78° C. A slurry of 1,2,3-Cp^{Me3} (70.2 mg, 0.615 mmol) in −78° C. Et₂O (15 mL) was transferred to this solution via cannula and the contents stirred at this temperature for 1 h. The schlenk was then slowly warmed to room temperature before being stirred for a further hour. The solvent was removed in vacuo, the contents dissolved in benzene (3×2 mL) and filtered via cannula into a small schlenk. This solution was frozen at −78° C., exposed to dynamic vacuum, then removed from the cool bath to allow the benzene to sublime overnight. This solid was washed with −78° C. pentane (2×3 mL) and dried under vacuum overnight giving the product as a light tan powder in 53% yield (137 mg, 0.326 mmol).

¹H NMR (C₆O₆) δ (ppm): 1.64 {(2,6)-Me₂, 6H, s}; 1.76 {Cp(1,3)-Me₂, 6H, s}; 1.90 {(3,5)-Me₂, 6H, s}; 2.03 {Cp(2)-Me, 3H, s}; 2.14 {(1,7)-Me₂, 6H, s}; 4.82 {Cp(4,5)-CH}

¹³C NMR (C₆D₆) δ (ppm): 10.5 {(2,6)-Me₂}; 11.8 {(Cp(2)-Me₂}; 12.1 {Cp(1,3)-Me₂}; 12.6 {(1,7)-Me₂}; 13.2 {(3,5)-Me₂}; 104.2 (3,5); 105.1 {Cp(4,5)}; 112.1 (1,7); 118.9 {Cp(1,3)}; 119.3 (4); 125.1 (2,6); 126.8 (8); 127.3 {Cp(2)}

### Example 1c—Synthesis of ZrPn*IndCl

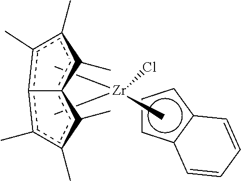

[ZrPn*(μ-Cl)_{3/2}]₂(μ-Cl)₂Li.THF_{(1.02)} (300 mg, 0.369 mmol) was dissolved in Et₂O (20 mL) and cooled to −78° C. A slurry of IndLi (90.1 mg, 0.738 mmol) was transferred to this solution via cannula and the contents stirred for 1 h. The vessel was allowed to warm to room temperature, then stirred for a further hour, before the solvent was removed under vacuum. The solid was redissolved sparingly in benzene (3×2 mL) and filtered via cannula into a small schlenk. The solvent was frozen at −78° C., removed from the cold bath, and exposed to dynamic vacuum overnight. The resultant powder was washed with −78° C. pentane (3×2 mL) and dried under vacuum for 4 hours giving the product as an orange-green powder in 75% yield (239 mg, 0.558 mmol).

¹H NMR (C₆D₆) δ (ppm): 1.49 {(2,6)-Me₂, 6H, s}; 1.91 {(3,5)-Me₂, 6H, s}; 1.94 {(1,7)-Me₂, 6H, s}; 5.51 {Ind(2,9), 2H, d (³J_{H—H}=3.4 Hz)}; 5.78 {Ind(1), 1H, t (³J_{H—H}=3.4 Hz)}; 6.93 {Ind(5,6), 2H, m}; 7.51 {Ind(4,7), 2H, m}

¹³C NMR (C₆D₆) δ (ppm): 10.4 {(2,6)-Me₂}; 12.5 {(3,5)-Me₂}; 13.1 {(1,7)-Me₂}; 95.2 {Ind(2,9)}; 105.8 (3,5); 112.4 (1,7); 119.1 {Ind(1)}; 119.8 (4); 123.4 {Ind(4,7)}; 124.0 {Ind(5,6)}; 126.3 (2,6); 126.5 {Ind(3,8); 128.6 (8)

### Example 1d—Synthesis of ZrPn*FluCl

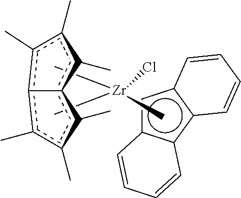

[ZrPn*(μ-Cl)_{3/2}]₂(μ-Cl)₂Li.THF_{(1.02)} (51 mg, 0.060 mmol) and LiFlu (21 mg, 0.12 mol) were introduced into an NMR tube and dissolved in 0.5 mL of C₆D₆ and the solution turned bright yellow instantly. The reaction mixture was heated to 80° C. for 96 h and the benzene was filtered through celite. The benzene was removed to afford Pn*ZrFluCl as a pale green solid. Yield: 26 mg (80% yield).

¹H NMR (benzene-d₆, 400 MHz): δ 1.25 1.76 2.07 (s, 6H, Pn-CH₃), 4.69 (s, 1H, Flu-H), 7.04 (m, 2H, Flu-H), 7.08 (m, 2H, Flu-H), 7.17 (d, 2H, Flu-H, ³J_{HH}=7.72 Hz), 8.31 (d, 2H, Flu-H, ³J_{HH}=8.29 Hz).

¹³C{¹H} NMR (benzene-d₆, 100 MHz): δ 9.5 12.5 12.8 (Pn-CH₃), 75.5 (Flu(C)), 118.5 (Flu(C)), 121.9 (Flu(C)), 126.5 (Flu(C)), 127.0 (Flu(C)).

### Example 1e—Synthesis of Pn*ZrCpⁿ^{_{Bu}}Cl

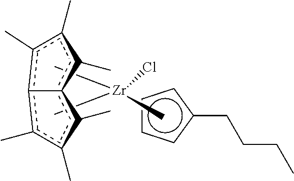

LiCpⁿ^{_{Bu}} (79 mg, 0.617 mmol) was ground with an agate pestle and mortar and added to an ampoule containing [Pn*Zr(μ-Cl)_{3/2}]₂(μ-Cl)₂Li.thf_{(0.988)} (250 mg, 0.308 mmol). Et₂O (20 mL) was cooled to −78° C. and transferred onto the solids and stirred vigorously for 1 h. The ampoule was removed from the cold bath and sonicated for 1 h. The reaction mixture was then stirred for a further hour at room temperature before the solvent was removed under vacuum to afford an orange oil that crystallises slowly on standing. Following extraction into benzene (3×2 mL) and lyophilisation, Pn*ZrCpⁿ^{_{Bu}}Cl was afforded as a brown solid in 67% yield (179 mg, 0.412 mmol).

Single crystals suitable for an X-ray diffraction study were grown from a saturated (Me₃Si)₂O solution at −35° C. Anal Calcd (found) for C₂₃H₃₁ClZr: C, 63.63 (63.71); H, 7.20 (7.21).

¹H NMR (400 MHz, C₆D₆) δ (ppm): 0.87 (t, 3H, ³J_{H—H}=7.2 Hz, CH₃(CH₂)₃-Cp); 1.30 (m, 2H, CH₃CH₂(CH₂)₂-Cp); 1.42 (m, 2H, CH₃CH₂CH₂CH₂-Cp); 1.70 (s, 6H, 2,6-Me-Pn*); 1.84 (s, 6H, 3,5-Me-Pn*); 2.11 (s, 6H, 1,7-Me-Pn*); 2.6 (m, 2H, CH₃CH₂CH₂CH₂-Cp); 5.15 (t, 2H, ³J_{H—H}=2.7 Hz, 3,4-H-Cp); 5.68 (t, 2H, ³J_{H—H}=2.7 Hz, 2,5-H-Cp).

¹³C{¹H} NMR (100 MHz, C₆D₆) δ (ppm): 11.3 (2,6-Me-Pn*); 12.6 (1,7-Me-Pn*); 13.3 (3,5-Me-Pn*); 14.3 (CH₃CH₂CH₂CH₂-Cp); 23.0 (CH₃CH₂(CH₂)-Cp); 29.3 (CH₃CH₂CH₂CH₂-Cp); 33.8 (Cp-CH₂—CH₂—); 105.2 (3,5-Pn*); 106.0 (3,4-Cp); 112.2 (1,7-Pn*); 113.4 (2,5-Cp); 119.5 (4-Pn*); 125.6 (2,6-Pn*); 128.6 (8-Pn*); 130.0 (1-Cp).

### Example 1f—Synthesis of Pn*ZrCp^{Me}(Me)

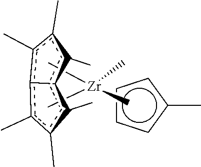

A solution of Pn*ZrCp^{Me}Cl (200 mg, 0.510 mmol) in toluene (15 mL) at −78° C. was added to a solution of MeLi (1.6 M in Et₂O, 319 μL, 0.510 mmol) in toluene at −78° C. The reaction mixture was stirred for 1 h before being exposed to dynamic vacuum while still in the cold bath. The solution was removed from the cold bath so that the removal of the solvent kept the temperature below 0° C. The solid was extracted with hexane (4×5 mL) and the combined extracts concentrated to 15 mL and cooled to −80° C. in a freezer overnight, yielding a yellow microcrystalline solid. The supernatant was removed and the solid dried in vacuo for 4 h to yield Pn*ZrCp^{Me}(Me) in 50% yield (95 mg, 0.256 mmol).

Single crystals suitable for an X-ray diffraction study were grown from slow-evaporation of a benzene solution. Anal Calcd (found) for C₂₁H₂₈Zr: C, 67.86 (67.73); H, 7.59 (7.71).

¹H NMR (400 MHz, C₆D₆) δ (ppm): −0.74 (s, 3H, Zr-Me); 1.63 (s, 6H, 2,6-Me-Pn*); 1.85 (s, 3H, Me-Cp, 3H, s); 1.99 (s, 6H, 3,5-Me-Pn*); 2.00 (s, 6H, 1,7-Me-Pn*); 5.15 (t, 2H, ³J_{H—H}=2.6 Hz, 2,5-H-Cp); 5.37 (t, 2H, ³J_{H—H}=2.6 Hz, 3,4-H-Cp).

¹³C{¹H} NMR (C₆D₆) δ (ppm): 10.6 (Zr—CH₃); 10.9 (2,6-Me-Pn*); 12.4 (3,5-Me-Pn*); 13.4 (1,7-Me-Pn*); 14.0 (Me-Cp); 102.2 (1,7-Pn*); 105.5 (3,4-Cp); 106.4 (3,5-Pn*); 111.4 (2,5-Cp); 116.9 (8-Pn*); 119.8 (1-Cp); 123.1 (2,6-Pn*); 123.4 (4-Pn*).

### Example 1g—Synthesis of Pn*ZrCp(Me)

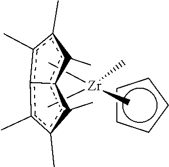

A solution of Pn*ZrCpCl (250 mg, 0.661 mmol) in toluene (15 mL) at −78° C. was added to a solution of MeLi (1.6 M in Et₂O, 415 μL, 0.664 mmol) in toluene at −78° C. The reaction mixture was stirred for 1 h before being exposed to dynamic vacuum while still in the cold bath. The solution was removed from the cold bath so that the removal of the solvent kept the temperature below 0° C. The solid was extracted with hexane (4×5 mL) and the combined extracts concentrated to 15 mL and cooled to −80° C. in a freezer overnight, yielding a yellow microcrystalline solid. The supernatant was removed and the solid dried in vacuo for 4 h to yield Pn*ZrCp(Me) in 68% yield (160 mg, 0.447 mmol).

Single crystals suitable for an X-ray diffraction study were grown from slow-evaporation of a benzene solution.

¹H NMR (400 MHz, C₆D₆) δ (ppm): −0.72 (s, 1H, Zr-Me); 1.64 (s, 6H, 2,6-Me-Pn*); 1.96 (s, 6H, 3,5-Me-Pn*); 1.97 (s, 6H, 1,7-Me-Pn*); 5.46 (s, 5H, Cp);

¹³C{¹H} NMR (C₆D₆) δ (ppm): 10.0 (Zr—CH₃); 11.2 (2,6-Me-Pn*); 12.3, 13.4 (3,5-Me-Pn* & 1,7-Me-Pn*—indistinguishable by HSQC); 102.5 (1,7-Pn*); 106.4 (3,5-Pn*); 108.9 (Cp); 116.9 (8-Pn*); 123.3 (2,6-Pn*); 123.6 (4-Pn*).

### Example 1h—Synthesis of Pn*ZrCp(H)

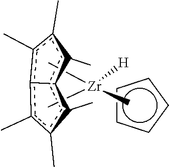

An ampoule was charged with a solution of Pn*ZrCpCl (150 mg, 0.397 mmol) in toluene (15 mL) and potassium triethylborohydride (1.0 M solution in THF, 417 μL, 0.417 mmol) and stirred for 48 h. The volatiles were removed in vacuo, the solid extracted with pentane (4×5 mL) and the combined extracts concentrated to 15 mL before being cooled to −80° C. in a freezer overnight. The supernatant was removed and the solid dried under vacuum for 4 h to yield Pn*ZrCp(H) in 42% yield (57 mg, 0.166 mmol).

Single crystals suitable for an X-ray diffraction study were grown from slow-evaporation of a benzene solution.

¹H NMR (400 MHz, C₆D₆) δ (ppm): 0.69 (d, 1H, J=1.6 Hz, Zr—H); 1.69 (s, 6H, 2,6-Me-Pn*); 2.05 (s, 6H, 3,5-Me-Pn*); 2.59 (s, 6H, 1,7-Me-Pn*); 5.54 (s, 5H, Cp);

¹³C{¹H} NMR (C₆D₆) δ (ppm): 10.8 (2,6-Me-Pn*); 12.8 (3,5-Me-Pn*); 14.4 (1,7-Me-Pn*); 103.9 (3,5-Pn*); 105.5 (Cp); 108.6 (1,7-Pn*); 117.5 (4-Pn*); 121.4 (8-Pn*); 121.4 (2,6-Pn*).

### Example 1i—Synthesis of Pn*ZrCp(ⁿBu)

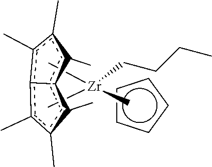

A solution of Pn*ZrCpCl (200 mg, 0.529 mmol) in toluene (15 mL) at −78° C. was added to a solution of ⁿBuLi (1.6 M in Et₂O, 347 μL, 0.555 mmol) in toluene at −78° C. The reaction mixture was stirred for 1 h, allowed to slowly warm to room temperature and stirred for a further hour. The volatiles were then removed under dynamic vacuum and the solid extracted with pentane (4×5 mL) and the combined extracts concentrated to 15 mL and cooled to −80° C. in a freezer overnight, yielding a yellow microcrystalline solid. The supernatant was removed and the solid dried in vacuo for 4 h to yield Pn*ZrCp(ⁿBu) in 57% yield (120 mg, 0.300 mmol).

¹H NMR (400 MHz, C₆D₆) δ (ppm): −0.14 (m, 2H, Zr—CH₂—); 1.16 (t, 3H, ³J_{H—H}=7.3 Hz, Zr—(CH₂)₃—CH₃); 1.42 (m, 2H, Zr—CH₂—CH₂—); 1.58 (m, 2H, Zr—(CH₂)₂—CH₂—); 1.63 (s, 6H, 2,6-Me-Pn*); 1.96 (s, 6H, 3,5-Me-Pn*); 1.99 (s, 6H, 1,7-Me-Pn*); 5.50 (s, 5H, Cp);

¹³C{¹H} NMR (C₆D₆) δ (ppm): 11.0 (2,6-Me-Pn*); 12.1 (3,5-Me-Pn*); 13.6 (1,7-Me-Pn*); 14.6 (Zr—(CH₂)₃—CH₃); 28.9 (Zr—CH₂—); 32.4 (Zr—(CH₂)₂—CH₂—); 36.7 (Zr—CH₂—CH₂—); 102.4 (3,5-Pn*); 106.4 (1,7-Pn*); 108.5 (Cp); 116.7 (4-Pn*); 123.1 (8-Pn*); 123.5 (2,6-Pn*).

### Example 1j—Synthesis of Pn*ZrCp(NMe₂)

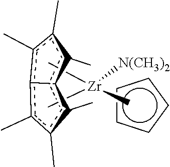

An ampoule was charged with Pn*ZrCpCl (100 mg, 0.27 mmol), LiNMe₂ (19 mg, 0.37 mmol) and benzene (20 mL) at room temperature. The resultant yellow solution was stirred for 3 days, filtered and the supernatant frozen at −78° C. and lyophilsed under dynamic vacuum. Pn*ZrCp(NMe₂) was isolated as a yellow powder in 83% yield (85 mg, 0.22 mmol).

¹H NMR (400 MHz, C₆D₆) δ (ppm): 1.82 (s, 6H, 2,6-Me-Pn*); 1.89 (s, 6H, 3,5-Me-Pn*); 2.09 (s, 6H, 1,7-Me-Pn*); 2.40 (s, 6H, N-Me₂); 5.72 (s, 5H, Cp)

¹³C{¹H} NMR (C₆D₆) δ (ppm): 11.3 (2,6-Me-Pn*); 12.2 (1,7-Me-Pn*); 13.8 (3,5-Me-Pn*); 48.2 (N-Me₂); 104.2 (3,5-Pn*); 108.0 (Cp); 112.5 (1,7-Pn*); 120.3 (4-Pn*); 125.1 (2,6-Pn*); 126.7 (8-Pn*).

### Example 1k—Synthesis of Pn*ZrCp(NPh₂)

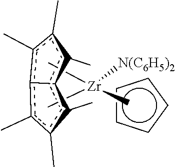

THF (20 mL) was cooled to −78° C. and added to Pn*ZrCpCl (100 mg, 0.27 mmol) and KNPh₂.THF_{0.27} (70 mg, 0.31 mmol). The solution was allowed to warm to room temperature, stirred for 16 h then filtered and dried under dynamic vacuum. The yellow solid was redissolved in a pentane (20 mL) and toluene (10 mL) mixture, then filtered. The filtrate was reduced to a minimum volume and placed in a freezer at −80° C. for 3 days. The resultant yellow crystalline solid was isolated by filtration and dried in vacuo to give Pn*ZrCp(NPh₂) in 60% yield (81 mg, 0.16 mmol).

¹H NMR (400 MHz, THF d⁸) δ (ppm): 1.58 (s, 6H, 3,5-Me-Pn*); 2.12 (s, 6H, 2,6-Me-Pn*); 2.20 (s, 6H, 1,7-Me-Pn*); 5.62 (s, 5H, Cp); 6.58 (m, 6H, N-Phₘₑₜₐ & N-Phₚₐᵣₐ), 7.00 (m, 4H, N-Phₒᵣₜₕₒ).

¹³C{¹H} NMR (THF d⁸) δ (ppm): 11.0 (3,5-Me-Pn*); 11.5 (2,6-Me-Pn*); 13.6 (1,7-Me-Pn*); 106.3 (1,7-Pn*); 111.2 (Cp); 112.0 (3,5-Pn*); 117.7 (N-Ph meta/para); 118.3 (8-Pn*); 118.3 (2,6-Pn*); 124.1 (N-Ph meta/para) 128.3 (4-Pn*); 128.5 (N-Ph ortho); 159.1 (N-Ph ipso).

### Example 1l—Synthesis of Pn*ZrCp^{Me}(OAm)

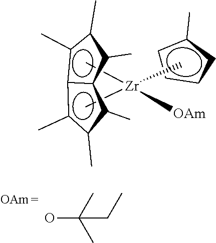

Pn*ZrCp^{Me}Cl (0.020 g, 0.051 mmol) and KO-2,6-ⁱPr-C₆H₃ (0.006 g, 0.051 mmol) were combined in C₆D₆ (0.5 mL) and sonicated for 2×30 minutes to afford a yellow solution and colourless precipitate. Analysis of the solution using 1H NMR spectroscopy indicated the formation of Pn*ZrCp^{Me}(OAm).

¹H NMR (benzene-d₆, 23° C.): δ 5.70 5.55 (app.t, 2H each, J_{HH}=2.7 Hz, C₅H₄Me), 2.07 (s, 6H, CH₃—Pn*), 2.02 (s, 3H, C₅H₄Me), 1.95 1.89 (s, 6H each, CH₃—Pn*), 1.48 (q, 2H, ³J_{HH}=7.4 Hz, C(CH₃)₂CH₂CH₃), 1.13 (s, 6H, C(CH₃)₂CH₂CH₃), 0.86 (t, 2H, ³J_{HH}=7.4 Hz, C(CH₃)₂CH₂CH₃).

### Example 1m—Synthesis of Pn*ZrCp^{Me}(O-2,6-Me-C₆H₃)

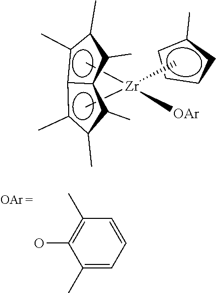

Pn*ZrCp^{Me}Cl (0.018 g, 0.046 mmol) and KO-2,6-Me-C₆H₃ (0.0090 g, 0.046 mmol) were combined in C₆D₆ (0.5 mL) and sonicated for 2×30 minutes to afford a yellow solution and colourless precipitate. After was followed by drying of the filtrate in vacuo to afford Pn*ZrCp^{Me}(O-2,6-Me-C₆H₃) as a pale yellow solid. Single crystals suitable for an X-ray diffraction study were grown from a pentane solution at −30° C.

¹H NMR (benzene-d₆, 23° C.): δ 7.17 (d, 2H, ³J_{HH}=7.4 Hz, 3,5-C₆H₃), 6.82 (t, 1H, ³J_{HH}=7.4 Hz, 4-C₆H₅), 5.47 5.20 (app.t, 2H each, J_{HH}=2.7 Hz, C₅H₄Me), 2.08 1.92 1.88 1.84 (s, 6H each, CH₃—Pn* or 2,6-Me-C₆H₃), 1.83 (s, 3H, C₅H₄Me).

### Example 1n—Synthesis of Pn*ZrCp^{Me}(O-2,6-ⁱPr-C₆H₃)

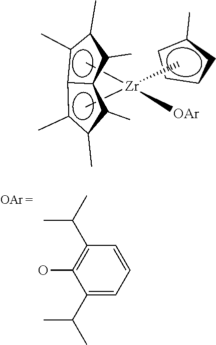

Pn*ZrCp^{Me}Cl (0.020 g, 0.051 mmol) and KO-2,6-ⁱPr-C₆H₃ (0.011 g, 0.051 mmol) were combined in C₆D₆ (0.5 mL) and sonicated for 2×30 minutes to afford a yellow solution and colourless precipitate. After was followed by drying of the filtrate in vacuo to afford Pn*ZrCp^{Me}(O-2,6-ⁱPr-C₆H₃) as a pale yellow solid.

¹H NMR (benzene-d₆, 23° C.): δ 7.17 (d, 2H, ³J_{HH}=7.5 Hz, 3,5-C₆H₃), 6.96 (t, 1H, ³J_{HH}=7.5 Hz, 4-C₆H₆), 5.63 5.22 (app.t, 2H each, J_{HH}=2.7 Hz, C₅H₄Me), 2.93 (sept., 2H, ³J_{HH}=6.8 Hz, CH(CH₃)₂), 2.01 1.90 (s, 6H each, CH₃-Pn*), 1.89 (s, 3H, C₆H₄Me), 1.87 (s, 6H, CH₃—Pn*), 1.35 1.21 (d, 2H each, ³J_{HH}=6.8 Hz, CH(CH₃)₂).

### Example 1o—Synthesis of Pn*ZrCp^{Me}(O-2,4-^{t}Bu-C₆H₃)

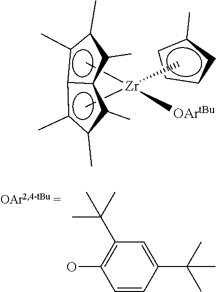

Pn*ZrCp^{Me}Cl (0.032 g, 0.082 mmol) and KO-2,4-^{t}Bu-C₆H₃ (0.020 g, 0.082 mmol) were combined in C₆D₆ (0.5 mL) and sonicated for 2×30 minutes to afford a yellow solution and colourless precipitate. After was followed by drying of the filtrate in vacuo to afford Pn*ZrCp^{Me}(O-2,6-^{t}Bu-C₆H₃) as a pale yellow solid.

¹H NMR (benzene-d₆, 23° C.): δ 7.57 7.26 (m, 1H each, 3,5,6-C₆H₃), 5.99 5.66 5.58 5.30 (m, 1H each, C₅H₄Me), 2.19 1.99 1.93 1.92 1.90 1.90 1.85 (s, 3H each, CH₃-Pn* or C₅H₄Me), 1.60 1.43 (s, 9H each, O-2,4-^{t}Bu-C₆H₃).

### Example 1p—Synthesis of Pn*ZrCp^{Me}(NMe₂)

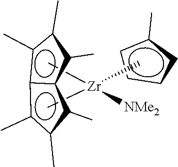

Pn*ZrCp^{Me}Cl (0.045 g, 0.11 mmol) and LiNMe₂ (0.0058 g, 0.11 mmol) were combined in C₆D₆ (0.5 mL) and sonicated 30 minutes to afford a yellow solution and colourless precipitate. After was followed by drying of the filtrate in vacuo to afford Pn*ZrCp^{Me}(NMe₂) as a pale yellow solid.

¹H NMR (benzene-d₆, 23° C.): δ 5.66 5.50 (m, 2H each, C₅H₄Me), 2.43 2.11 1.92 (s, 6H each, CH₃—Pn* or NMe₂), 1.92 (s, 3H, C₅H₄Me) 1.82 (s, 6H each, CH₃—Pn* or NMe₂).

### Comparative Example—Synthesis of Pn*ZrCp^{t}^{_{Bu}}Cl

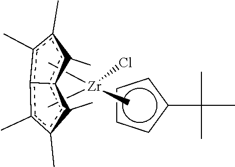

To [Pn*Zr(μ-Cl)_{3/2}]₂(μ-Cl)₂Li.Et₂O_{(1.21)} (300 mg, 0.362 mmol) in Et₂O (20 mL) at −78° C. was added a slurry of LiCp^{t}^{_{Bu}} in Et₂O (15 mL) at −78° C. The reaction mixture was warmed to room temperature over the course of 1 h, and then stirred for 1 h. The volatiles were removed under vacuum, and the solids extracted into benzene (3×2 mL) and lyophilised. The solid was washed with −78° C. pentane (2×3 mL) and dried under vacuum for 4 h to afford Pn*ZrCp^{t}^{_{Bu}}Cl in 80% yield (253 mg, 0.583 mmol). Analytical samples were prepared by recrystallising the product from pentane at −78° C.

Single crystals suitable for an X-ray diffraction study were grown from slow-evaporation of a benzene solution. Anal Calcd (found) for C₂₃H₃₁ClZr: C, 63.63 (63.55); H, 7.20 (7.33).

¹H NMR (400 MHz, C₆D₆) δ (ppm): 1.33 (s, 9H, ^{t}Bu-Cp); 1.71 (s, 6H, 2,6-Me-Pn*); 1.83 (s, 6H, 3,5-Me-Pn*); 2.09 (s, 6H, 1,7-Me-Pn*); 5.04 (t, 2H, ³J_{H—H}=2.8 Hz, 2,5-H-Cp); 5.96 (t, 2H, ³J_{H—H}=2.8 Hz, 3,4-H-Cp).

¹³C{¹H} NMR (100 MHz, C₆D₆) δ (ppm): 11.6 (2,6-Me-Pn*); 12.6 (1,7-Me-Pn*); 13.3 (3,5-Me-Pn*); 32.2 (CMe₃-Cp); 104.2 (2,5-Cp); 105.0 (3,5-Pn*); 112.3 (1,7-Pn*); 113.9 (3,4-Cp); 119.4 (4-Pn*); 126.1 (2,6-Pn*); 128.6 (8-Pn*); 138.8 (1-Cp).

### Example 2—Synthesis of Catalytic Compositions

### Example 2a—General Method for Supporting Catalytic Compounds on MAO-Modified Silica and MAO-Modified LDH

The MAO-modified silica or MAO-modified LDH was combined with the pre-catalyst and stirred together dry for 5 minutes. The stirring was halted and toluene (10 mL) was added to the mixture and heated to 60° C. for 1 h. The contents were manually swirled every 5 minutes and after 1 h were allowed to settle leaving a colored solid and a colorless solution. The supernatant was removed via cannula and the solid dried under vacuum for 4 h.

### Example 2b—Exemplary Synthesis of Silica Supported MAO-Complex Catalyst

To a Schlenk tube containing a slurry of silica (1.0 g, 17 mmol) in toluene (20 mL) was added to a solution of MAO (0.48 g, 8.3 mmol) in toluene (20 mL). The reaction mixture was heated to 80° C. for 2 h and was periodically agitated to afford a colourless solid with a clear, colourless supernatant. The reaction was cooled to room temperature and the supernatant removed. Removal of the volatiles in vacuo afforded silica-supported methylaluminoxane (SSMAO) as a free-flowing white powder. Yield: 1.24 g (85%). SSMAO (0.25-0.35 g) and the required amount of zirconocene catalyst in the SSMAO:complex ratio 1:0.005 or 1:0.088 were weighed into a Schlenk tube. The reactants were dissolved in toluene (40 mL) and the reaction mixture was heated to 60° C. for 1 h with periodic agitation to afford a pale yellow/green solid with a clear colourless supernatant. The reaction mixture was allowed to cool to room temperature and the supernatant removed. The volatiles were removed in vacuo to give SSMAO-[complex], a free-flowing pale-yellow/green solids. Yields: 39-78%

SSMAO-ZrPn*Cp^{Me}Cl IR: ū (cm⁻¹) 450, 700, 800, 1000-1300, 1450, 2950, 3400.
SSMAO-ZrPn*IndCl IR: ū (cm⁻¹) 450, 700, 800, 1000-1300, 1450, 2950, 3400.

### Example 3—Polymerisation Studies

### Example 3a—General Procedure for Solution-Phase Polymerisation of Ethylene

The catalyst (2 mg) was dissolved in toluene (2 mL). The ampoule was charged with MAO (250 eq) and toluene (50 mL), before 500 μL of the catalyst solution was transferred to the ampoule. The contents were placed in an oil bath at the required temperature and allowed to equilibrate for 5 minutes while the headspace is degassed. The flask is opened to ethylene (2 bar) and stirred at 1200 rpm for the duration of the experiment. The polymer is then filtered, washed with pentane (2×20 mL) and dried at 5 mbar overnight.

### Example 3b—General Procedure for Slurry Phase Polymerisation of Ethylene

An ampoule is charged with TiBA (150 mg, 0.756 mmol), toluene (50 mL) and the supported catalyst (10 mg). The contents are placed in an oil bath at the required temperature and allowed to equilibrate for 5 minutes while the headspace is degassed. The flask is opened to ethylene (2 bar) and stirred at 1200 rpm for the duration of the experiment. The polymer is then filtered, washed with pentane (2×20 mL) and dried at 5 mbar overnight.

### Example 3c—Ethylene Polymerisation (Solution Phase)

The complexes synthesised previously have been used in the solution polymerisation of ethylene in the conditions [M]:[MAO] of 1:250, 50 mL toluene, 60° C. and 5 minutes. The results are shown in FIG. 2, and summarised in Table 1 and compared with published compound Pn*ZrCpCl.

TABLE 1
Summary of the solution polymerisation of Pn*MCp^{R}Cl

| Complex | Activity Kg_{PE}/mol_{M}/h/bar |
|---|---|
| Pn*ZrCpCl | 2280 ± 139 |
| Pn*ZrCp^{Me}Cl | 3925 ± 638 |
| Pn*ZrCp^{1, 2, 3-Me}Cl | 2773 ± 469 |
| Pn*ZrIndCl | 3585 ± 129 |

It is clear from Table 1 that the compounds of the invention exhibit significantly improved activity when compared with the currently available Pn*ZrCpCl.

### Example 3d—Ethylene Polymerisation (Silica Supported Slurry Phase)

Three zirconium complexes were reacted with silica and used in the silica supported slurry polymerisation of ethylene in the conditions [M]:[MAO] of 1:1000, 50 mL hexanes, 60° C. and 60 minutes. The results are shown in FIG. 3.

### Example 3e—Ethylene Polymerisation (Solution Phase)

Following the procedure outlined in Example 3a, the catalytic activity of catalytic compounds in the polymerisation of ethylene was assessed. The results are outlined in Table 2 and FIG. 4.

TABLE 2
Solution phase ethylene polymerisation activities of
Pn*ZrCp^{R}Cl (Cp^{R} = Cp, Cp^{Me}, Cp^{tBu}, Cp^{nBu}, Cp^{Me3}, Ind) and
Pn*ZrCp^{Me}(Me). Polymerisation conditions: [Zr]:[MAO] =
1:250; 2 bar ethylene; 0.5 mg catalyst loading; 50
mL toluene; 60° C.; 5 minutes.

| | | | Activity |
|---|---|---|---|
| | Temperature | Time | (kg_{PE}/ |
| Complex | (° C.) | (minutes) | (mol_{Zr} · h · bar)) |
| Pn*ZrCpCl | 60 | 30 | 2280 ± 139 |
| Pn*ZrCp^{Me}Cl | 60 | 30 | 3353 ± 104 |
| Pn*ZrCp^{tBu}Cl | 60 | 30 | 789 ± 151 |
| Pn*ZrCp^{nBu}Cl | 60 | 30 | 3300 ± 16 |
| Pn*ZrCp^{Me3}Cl | 60 | 30 | 2773 ± 469 |
| Pn*ZrCp^{Ind}Cl | 60 | 30 | 3585 ± 129 |
| Pn*ZrCp^{Me}(Me) | 60 | 30 | 3307 ± 261 |

It is clear from Table 2 that the compounds of the invention exhibit significantly improved activity when compared with currently available Pn*ZrCpCl.

### Example 3f—Effect of Temperature on Catalytic Activity of ssMAO-Supported Pn*ZrCp^{Me}Cl and LDH-MAO-Supported Pn*ZrCp^{Me}Cl

The temperature dependence of ethylene polymerisation activity with ssMAO-supported Pn*ZrCp^{Me}Cl and LDH-MAO-supported Pn*ZrCp^{Me}Cl was assessed. The results are outlined in Table 3 and FIG. 5.

TABLE 3
Comparison of ethylene polymersation activities of supported
Pn*ZrCp^{Me}Cl (top to bottom): LDH-MAO, ssMAO. Slurry conditions:
[Zr]:[Al] = 1:200; 150 mg TiBA co-catalyst;
2 bar ethylene; 10 mg catalyst loading; 50 mL toluene; 30 minutes.

| | | | Activity |
|---|---|---|---|
| | Temperature | Time | (kg_{PE}/ |
| Complex | (° C.) | (minutes) | (mol_{Zr} · h · bar)) |
| Pn*ZrCp^{Me}Cl - LDH-MAO | 40 | 30 | 1116 ± 48 |
| Pn*ZrCp^{Me}Cl - LDH-MAO | 50 | 30 | 1206 ± 40 |
| Pn*ZrCp^{Me}Cl - LDH-MAO | 60 | 30 | 1501 ± 30 |
| Pn*ZrCp^{Me}Cl - LDH-MAO | 70 | 30 | 1522 ± 131 |
| Pn*ZrCp^{Me}Cl - LDH-MAO | 80 | 30 | 1612 ± 200 |
| Pn*ZrCp^{Me}Cl - ssMAO | 40 | 30 | 504 ± 43 |
| Pn*ZrCp^{Me}Cl - ssMAO | 50 | 30 | 563 ± 10 |
| Pn*ZrCp^{Me}Cl - ssMAO | 60 | 30 | 458 ± 63 |
| Pn*ZrCp^{Me}Cl - ssMAO | 70 | 30 | 850 ± 61 |
| Pn*ZrCp^{Me}Cl - ssMAO | 80 | 30 | 943 ± 97 |

Table 3 suggests that LDH-MAO supported catalysts generally produce increased activities relative to ssMAO supported catalysts.

### Example 3g—Polyethylene Characteristics

The molecular weight (M_{w} and Mₙ) and polydispersity index (PDI) of polyethylenes prepared by solution phase polymerisation using various catalytic compounds were determined. The results are outlined in Table 4 and FIG. 6.

TABLE 4
Polymer molecular weight, M_{w} for solution ethylene polymerisation
at 60° C. with Pn*ZrCp^{R}Cl (Cp^{R} = Cp^{Me}, Cp^{tBu},
Cp^{Me3}, Ind) PDIs are also given. Polymerisation conditions:
[Zr]:[MAO] = 1:250; 2 bar ethylene; 0.5
mg catalyst loading; 50 mL toluene; 60° C.; 5 minutes.

| | Temperature | Time | | | |
|---|---|---|---|---|---|
| Complex | (° C.) | (minutes) | M_{w} | Mₙ | PDI |
| Pn*ZrCpCl | 60 | 30 | 470000 | 194000 | 2.4 |
| Pn*ZrCp^{Me}Cl | 60 | 30 | 526667 | 189667 | 2.7 |
| Pn*ZrCp^{tBu}Cl | 60 | 30 | 145000 | 35000 | 4.1 |
| Pn*ZrCp^{Me3}Cl | 60 | 30 | 195000 | 82000 | 2.4 |
| Pn*ZrCp^{Ind}Cl | 60 | 30 | 391667 | 128000 | 3.1 |

The data from Table 4 indicates significant control over polymer molecular weight can be achieved by variation of Cp^{R} substituent.

### Example 3h—Effect of Temperature on Solution Phase Catalytic Activity of Pn*ZrCp^{Me}Cl and Characteristics of Resulting Polyethylene

The temperature dependence of solution phase ethylene polymerization activity and polymer molecular weight (M_{w}) with Pn*ZrCp^{Me}Cl was assessed. The results are outlined in Table 5 and FIG. 7.

TABLE 5
Temperature dependence of ethylene polymerisation activity with Pn*ZrCp^{Me}Cl.
Polymerisation conditions [Zr]:[sMAO] = 1:200; 150 mg TiBA co-catalyst;
2 bar ethylene; 10 mg catalyst loading; 50 mL toluene; 30 minutes.

| | Temperature | Time | Activity | | | |
|---|---|---|---|---|---|---|
| Complex | (° C.) | (minutes) | (kg_{PE}/(mol_{zr} · h · bar)) | M_{w} | Mₙ | PDI |
| Pn*ZrCp^{Me}Cl | 50 | 30 | 2207 ± 24 | 450000 | 167000 | 2.7 |
| Pn*ZrCp^{Me}Cl | 60 | 30 | 3353 ± 104 | 385000 | 164000 | 2.3 |
| Pn*ZrCp^{Me}Cl | 70 | 30 | 3127 ± 205 | 295000 | 124000 | 2.4 |

Table 5 suggests that polymer molecular weight can be further controlled by choice of reaction temperature, with concommitant changes to activity also observed.

### Example 3i—Morphology Studies

FIG. 8 shows the morphology of polyethylene prepared by the solution-phase polymerisation of ethylene using Pn*ZrCp^{Me}Cl, Pn*ZrIndCl and Pn*ZrCp^{tBu}Cl (comparator).

FIG. 8 shows that polymer morphology can be affected by choice of Cp^{R}.

While specific embodiments of the invention have been described herein for the purpose of reference and illustration, various modifications will be apparent to a person skilled in the art without departing from the scope of the invention as defined by the appended claims.

1. A compound of the formula I shown below: 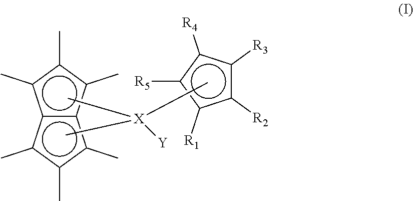
wherein
R₁ and R₂ are each independently hydrogen or linear (1-4C)alkyl, or R₁ and R₂ are linked such that, when taken in combination with the atoms to which they are attached, they form a 6-membered fused aromatic ring optionally substituted with one or more groups selected from (1-6C)alkyl, (2-6C)alkenyl, (2-6C)alkynyl, (1-6C)alkoxy, aryl, heteroaryl, carbocyclic and heterocyclic, wherein each aryl, heteroaryl, carbocyclic and heterocyclic group is optionally substituted with one or more groups selected from (1-6C)alkyl, (2-6C)alkenyl, (2-6C)alkynyl, (1-6C)alkoxy, halo, amino, nitro, cyano, (1-6C)alkylamino, [(1-6C)alkyl]₂amino and —S(O)₂(1-6C)alkyl;
R₃ and R₄ are each independently hydrogen or linear (1-4C)alkyl, or R₃ and R₄ are linked such that, when taken in combination with the atoms to which they are attached, they form a 6-membered fused aromatic ring optionally substituted with one or more groups selected from (1-6C)alkyl, (2-6C)alkenyl, (2-6C)alkynyl, (1-6C)alkoxy, aryl, heteroaryl, carbocyclic and heterocyclic, wherein each aryl, heteroaryl, carbocyclic and heterocyclic group is optionally substituted with one or more groups selected from (1-6C)alkyl, (2-6C)alkenyl, (2-6C)alkynyl, (1-6C)alkoxy, halo, amino, nitro, cyano, (1-6C)alkylamino, [(1-6C)alkyl]₂amino and —S(O)₂(1-6C)alkyl;
R₅ is hydrogen or linear (1-4C)alkyl;
X is selected from zirconium or hafnium; and
Y is selected from halo, hydride, a phosphonated, sulfonated or borate anion, or a (1-6C)alkyl, (2-6C)alkenyl, (2-6C)alkynyl, (1-6C)alkoxy, —C(O)NRₐR_{b}, —NRₐR_{b}, aryl or aryloxy group which is optionally substituted with one or more groups selected from halo, (1-4C)alkyl, nitro, NRₐR_{b}, phenyl, (1-6C)alkoxy, —C(O)NRₐR_{b}, or Si[(1-4C)alkyl]₃;
wherein Rₐ and R_{b} are independently hydrogen or (1-4C)alkyl;
with the proviso that the compound is not one of the following:

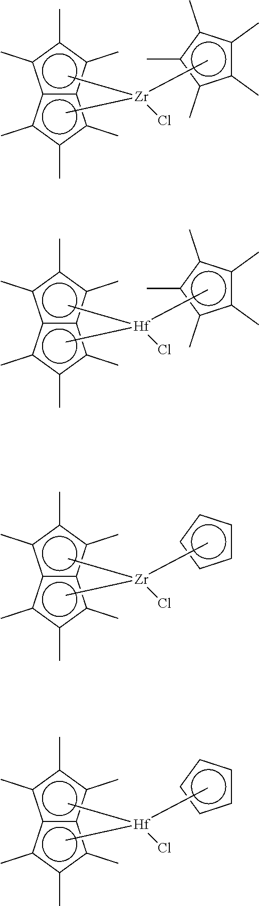

2. The compound of claim 1, wherein at least one of R₁, R₂, R₃, R₄ and R₅ is a group other than H.

3. The compound of claim 1, wherein R₁ and R₂ are each independently hydrogen or linear (1-4C)alkyl, or R₁ and R₂ are linked such that, when taken in combination with the atoms to which they are attached, they form a 6-membered fused aromatic ring optionally substituted with one or more groups selected from (1-6C)alkyl, (2-6C)alkenyl, (2-6C)alkynyl, (1-6C)alkoxy, aryl, heteroaryl, carbocyclic and heterocyclic, wherein each aryl, heteroaryl, carbocyclic and heterocyclic group is optionally substituted with one or more groups selected from (1-6C)alkyl, (2-6C)alkenyl, (2-6C)alkynyl, (1-6C)alkoxy and halo.

4. The compound of claim 1, wherein R₁ and R₂ are each independently hydrogen or linear (1-4C)alkyl, or R₁ and R₂ are linked such that, when taken in combination with the atoms to which they are attached, they form a 6-membered fused aromatic ring optionally substituted with one or more groups selected from (1-6C)alkyl, (2-6C)alkenyl, (2-6C)alkynyl, (1-6C)alkoxy, aryl or heteroaryl, wherein each aryl or heteroaryl group is optionally substituted with one or more groups selected from (1-6C)alkyl, (2-6C)alkenyl, (2-6C)alkynyl, (1-6C)alkoxy and halo.

5. The compound of claim 1, wherein R₁ and R₂ are each independently hydrogen or linear (1-4C)alkyl, or R₁ and R₂ are linked such that, when taken in combination with the atoms to which they are attached, they form a 6-membered fused aromatic ring optionally substituted with one or more groups selected from (1-4C)alkyl, (2-4C)alkenyl, (2-4C)alkynyl, (1-4C)alkoxy, aryl or heteroaryl, wherein each aryl or heteroaryl group is optionally substituted with one or more groups selected from (1-4C)alkyl, (2-4C)alkenyl, (2-4C)alkynyl, (1-4C)alkoxy and halo.

6. The compound of claim 1, wherein R₁ and R₂ are each independently hydrogen or linear (1-4C)alkyl, or R₁ and R₂ are linked such that, when taken in combination with the atoms to which they are attached, they form a 6-membered fused aromatic ring.

7. The compound of claim 1, wherein R₃ and R₄ are each independently hydrogen or linear (1-4C)alkyl, or R₃ and R₄ are linked such that, when taken in combination with the atoms to which they are attached, they form a 6-membered fused aromatic ring optionally substituted with one or more groups selected from (1-6C)alkyl, (2-6C)alkenyl, (2-6C)alkynyl, (1-6C)alkoxy, aryl, heteroaryl, carbocyclic and heterocyclic, wherein each aryl, heteroaryl, carbocyclic and heterocyclic group is optionally substituted with one or more groups selected from (1-6C)alkyl, (2-6C)alkenyl, (2-6C)alkynyl, (1-6C)alkoxy and halo.

8. The compound of claim 1, wherein R₃ and R₄ are each independently hydrogen or linear (1-4C)alkyl, or R₃ and R₄ are linked such that, when taken in combination with the atoms to which they are attached, they form a 6-membered fused aromatic ring optionally substituted with one or more groups selected from (1-6C)alkyl, (2-6C)alkenyl, (2-6C)alkynyl, (1-6C)alkoxy, aryl or heteroaryl, wherein each aryl or heteroaryl group is optionally substituted with one or more groups selected from (1-6C)alkyl, (2-6C)alkenyl, (2-6C)alkynyl, (1-6C)alkoxy and halo.

9. The compound of claim 1, wherein R₃ and R₄ are each independently hydrogen or linear (1-4C)alkyl, or R₃ and R₄ are linked such that, when taken in combination with the atoms to which they are attached, they form a 6-membered fused aromatic ring optionally substituted with one or more groups selected from (1-4C)alkyl, (2-4C)alkenyl, (2-4C)alkynyl, (1-4C)alkoxy, aryl or heteroaryl, wherein each aryl or heteroaryl group is optionally substituted with one or more groups selected from (1-4C)alkyl, (2-4C)alkenyl, (2-4C)alkynyl, (1-4C)alkoxy and halo.

10. The compound of claim 1, wherein R₃ and R₄ are each independently hydrogen or linear (1-4C)alkyl, or R₃ and R₄ are linked such that, when taken in combination with the atoms to which they are attached, they form a 6-membered fused aromatic ring.

11. The compound of claim 1, wherein R₅ is hydrogen.

12. The compound of claim 1, wherein the compound has a structure according to any of formulae Ia, Ib and Ic shown below: 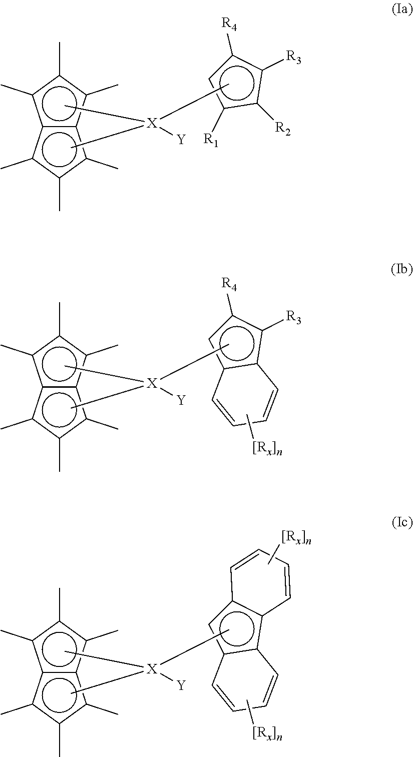
wherein
R₁, R₂, R₃ and R₄ are each independently H, methyl or ethyl;
each Rₓ is independently (1-4C)alkyl, (1-4C)alkoxy or halo; and
each n is 0, 1, 2, 3, or 4.

13. The compound of claim 1, wherein X is Zr.

14. The compound of claim 1, wherein Y is selected from halo, hydride, a phosphonated, sulfonated or borate anion, or a (1-6C)alkyl, (2-6C)alkenyl, (2-6C)alkynyl, (1-6C)alkoxy, aryl or aryloxy group which is optionally substituted with one or more groups selected from halo and (1-4C)alkyl.

15. The compound of claim 1, wherein Y is selected from halo, hydride, or a (1-6C)alkyl, (2-6C)alkenyl, (2-6C)alkynyl, (1-6C)alkoxy, aryl or aryloxy group which is optionally substituted with one or more groups selected from halo and (1-4C)alkyl.

16. The compound of claim 1, wherein Y is selected from halo, hydride, or a (1-4C)alkyl, (2-4C)alkenyl, (2-4C)alkynyl, (1-4C)alkoxy, aryl or aryloxy group which is optionally substituted with one or more groups selected from halo and (1-4C)alkyl.

17. The compound of claim 16, wherein Y is halo.

18. The compound of claim 17, wherein Y is Cl, Br or I.

19. The compound of claim 1, wherein the compound is selected from:

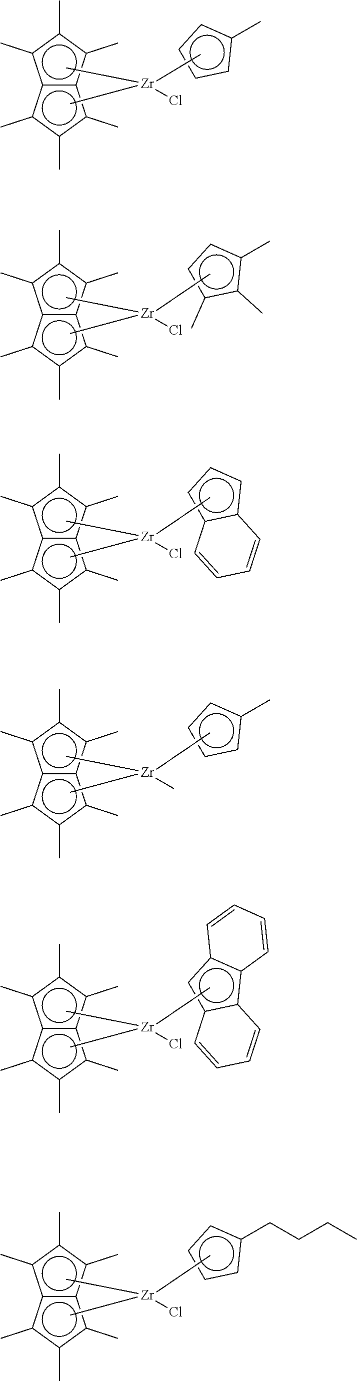

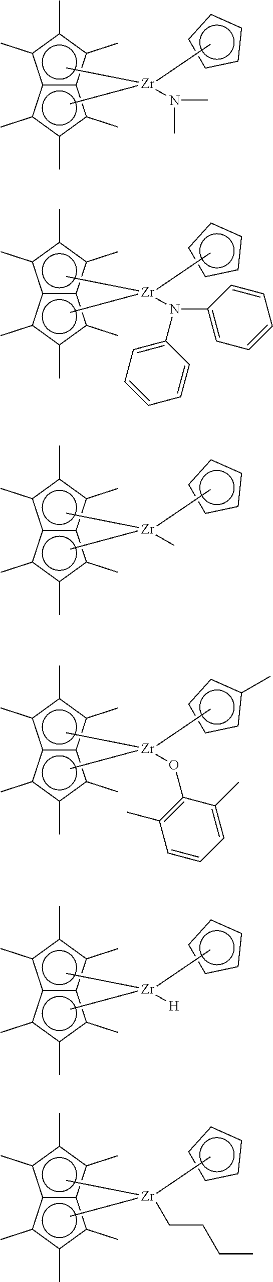

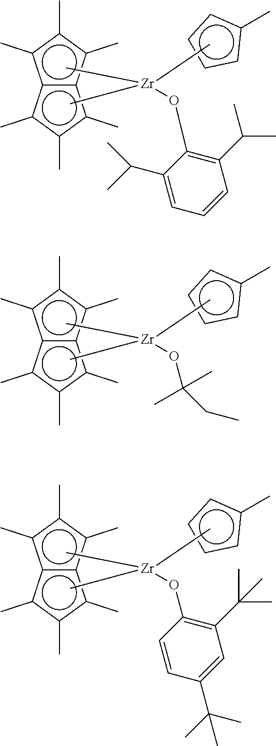

20. The compound of claim 1, wherein the compound is selected from:

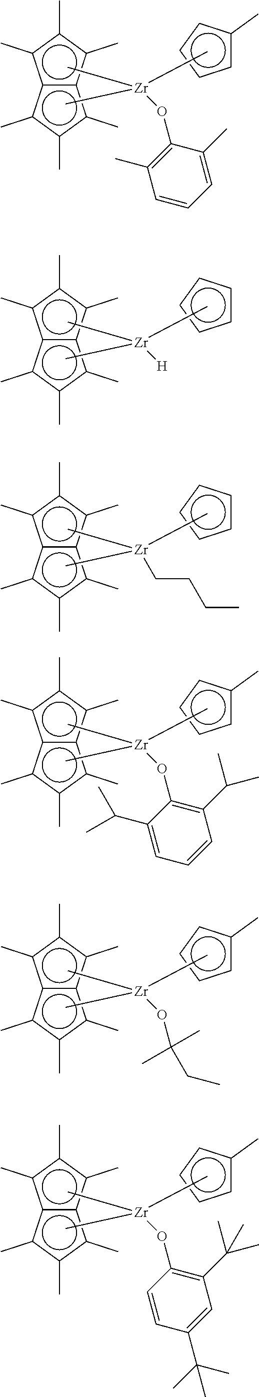

21. A composition comprising a compound of claim 1, and an activator.

22. The composition of claim 21, wherein the activator is an alkyl aluminium compound.

23. The composition of claim 21, wherein the activator is methylaluminoxane (MAO), triisobutylaluminium (TIBA), diethylaluminium (DEAC) or triethylaluminium (TEA).

24. The composition of claim 21, wherein the compound is immobilized on a support.

25. The composition of claim 24, wherein the support is an activated support.

26. The composition of claim 25, wherein the activated support is methylaluminoxane-activated silica or methylaluminoxane-activated layered double hydroxide.

27.-28. (canceled)

29. A process for polymerising one or more olefins, said process comprising the step of polymerising one or more olefins in the presence of:
(i) a compound of claim 1, or a composition of claim 21;
(ii) an activator.

30. The process of claim 29, wherein the compound of claim 1 is immobilized on a support or an activated support.

31. The process of claim 28, wherein the olefins are ethene monomers, optionally comprising 1-10 wt % of a (4-8C) α-olefin other than ethane.
